(19) United States
(12) Patent Application Publication
(10) Pub. No.: US 2009/0304551 A1
(43) Pub. Date: Dec. 10, 2009

(54) Ultra Sensitive Tapered Fiber Optic Biosensor For Pathogens, Proteins, and DNA

(75) Inventors: Rajakkannu Mutharasan, West Chester, PA (US); Mohana P. Shankar, Havertown, PA (US); Angela Shing Yan Leung, Philadelphia, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: DREXEL UNIVERSITY, Philadelphia, PA (US)

(21) Appl. No.: 12/162,447

(22) PCT Filed: Jan. 26, 2007
(86) PCT No.: PCT/US07/61146

§ 371 Date: Jul. 28, 2008

Related U.S. Application Data
(60) Provisional application No. 60/763,529, filed on Jan. 31, 2006.
(60) Provisional application No. 60/868,819, filed on Dec. 6, 2006.

(51) Int. Cl. G01N 21/01

(52) U.S. Cl. 422/82.11; 422/82.05

(57) ABSTRACT

A biconically tapered optical fiber serves as a biosensor at all optical wavelengths of interest ranging from UV to far IR at subfemtogram per mL sensitivity. The biconically tapered sensor detects biomaterials such as pathogenic species, proteins and DNA and others biological analytes. Although it uses the principles of evanescent fields, absorption, adsorption, fluorescence capture and retransmission through the fiber, the detection at the sub-nanogram per mL level is achieved primarily by adsorption or a surface activity due to a refractive index change. The geometry of the biconically tapered optical sensor affects its performance. The sensing modality is achieved in situ with a source connected at one end of a tapered fiber and a suitable detector at the other end. The tapered region is optionally immobilized with a recognition molecule such as an antibody to the target antigen or a complementary DNA strand. The sample is brought in contact with the tapered region either in batch mode or in a flow mode.

### STATEMENT OF GOVERNMENT INTEREST

This invention was reduced to practice with Government support under Grant No. 0329793 awarded by the National Science Foundation; the Government is therefore entitled to certain rights to this invention.

### BACKGROUND OF THE INVENTION

1. Field of the Invention

The present invention is related to devices and sensors that detect and measure small quantities of biological entities or pathogens such as bacteria and viruses, proteins and DNA in liquid test samples. In particular, this invention relates to a biconical continuous fiber optic tapered sensor and an apparatus including the sensor.

2. Brief Description of the Prior Art

Commercially available optical fibers are thin cylindrical dielectric waveguides that have been developed to send light for applications in telecommunication. They consist of three components: a central core, cladding surrounding the central core, and a protective polymer coating or buffer outside the cladding. Both the core and cladding are usually made of pure silica glass. For light transmission in the fiber to be efficient, the core needs to have a higher index of refraction than the cladding. To achieve this, a small, controlled amount of dopant, typically germanium oxide for silica fibers, is added to the core. Since the refractive index of the glass core is greater than that of the cladding, light traveling in the core remains confined within the core due to total internal reflection as long as the light strikes the core-cladding interface at an angle greater than the critical angle. Thus, optical fibers are able to transmit light through long distances with little loss of intensity.

Tapered fibers have been increasingly used in sensors in a wider variety of applications requiring physical, chemical, biochemical and clinical measurements. As evanescent wave sensors, tapered fibers have been used more extensively than conventional fibers due to their faster response, the high sensitivity of the tapered region, the highly localized nature of the evanescent field and their compatibility with real-time analysis. By tapering the fibers, the sensitivity of sensors employing the fibers can be significantly improved, since the taper facilitates access to the evanescent field in the tapered region, allowing it to interact more strongly with the surrounding medium. The increased sensitivity in the evanescent field of the tapered fibers also results in increased sensitivity for absorption and fluorescence measurements, thereby providing better performance. Evanescent field sensors have been widely investigated for the detection of chemicals, biological entities and physical properties.

The highest sensitivity in prior art sensors is on the order of nanograms (ng) per milliliter (ml) for detecting biological analytes. In the field of biology and biotechnology, it is well known that antibodies or complementary strands of DNA can be used to determine the presence of a specific pathogen, protein or DNA. The binding of the target antigen to the antibody is often determined by the use of a tagged (often a fluorogenic tag) second antibody. For example see: U.S. Pat. No. 6,136,611. Fluorescence-based detection has been the norm for high sensitivity detection. It has been used in the context of fiber optic evanescent wave sensors in a number of a number of U.S. patents, including at least U.S. Pat. Nos. 6,136,611, 4,447,546, 4,582,809, 4,654,532, 4,716,121 and 4,909,990.

Protein detection at sub-nanogram per mL concentrations, without extensive sample preparation, remains a challenge and has significant applications in many fields including medical diagnostics and anti-bioterrorism monitoring. In medical applications, detection of low concentrations of proteins aids early disease diagnosis because many proteins are markers for diseases. For example, cancerous and normal cells produce different proteins at various levels, and detection of these small differences can lead to a timely cancer diagnosis. In the context of homeland security, the ability to detect neurotoxins and enterotoxins at low concentrations (<50 pg/mL) is needed to effectively prevent and contain massive bio-terrorist attacks.

While traditional methods of protein detection are accurate, they are slow and depend on sophisticated instruments and extensive sample preparation. Such methods include scanning electrochemical microscopy (SECM), atomic force microscopy (AFM), and western blotting. Methods for protein measurement include the Lowry method, BCA, and the Biuret method. Some of these methods use chemicals to react with the protein to form a product, which is then measured spectrophotometrically, while others are based on the separation of proteins according to size. All of these methods require laborious preparation steps and careful calibration. With these methods, the biggest hurdle is that quantification is inadequately accurate for low concentration measurements. For example, the BCA method can only measure proteins at μg/mL levels.

It remains desirable to increase the sensitivity of sensors measuring biological analytes beyond the nanogram (ng) per milliliter (ml) detection level. In addition, it also remains desirable to achieve a certain degree of selectivity at the enhanced detection levels.

Moreover, prior art sensors are incapable of taking lifetime fluorescence readings, which would allow for easily portable sensors of the dip stick variety. Currently, lifetime measurements are generally obtained by using a cuvette assembly with a pulsed laser light source and advanced signal processing system. Lifetime fluorescence sensors of the prior art therefore are therefore limited by their large size, inaccuracy, non-localized measurement volume and the fact that excitation and emission signals are separated by an assumed linear dynamic model.

It therefore is desirable to develop a lifetime fluorescence sensor in order to create accurate portable sensors that can be incorporated in medical devices such as endoscopes and catheters.

### SUMMARY OF THE INVENTION

One aspect of the present invention is to provide an apparatus to detect pathogens and measure their concentrations at, for example, sub-nanogram per mL concentration levels. The present invention provides a system including optical components needed to achieve this goal. The optical components include a tapered fiber, a light source and a detector.

Another aspect of this invention is to provide a method to sense biomolecules in situ, using an uncut fiber. Unlike the traditional immunoassays, the nature and quantity of the biomolecules may be obtained substantially immediately via this means.

Further, in another aspect, the invention provides a method for carrying out an immunoassay with a sensor that can be used once and discarded. It also provides an alternative method of using the same sensor to undertake immunoassay repeatedly through a cleaning procedure, facilitating the ability of regenerative sensing.

In another aspect, certain embodiments of the invention provide the ability to work with samples in extremely low sample volumes. Along with extremely low sample volumes, certain aspects of the invention provide a means to detect very low concentrations of trace pathogens.

In another aspect, certain embodiments of the invention provide the ability to use off the shelf components that are relatively low cost, such as near and mid-IR laser diodes (used in telecommunications) and telecommunication quality single mode fiber.

In another aspect, certain embodiments of the invention provide the ability to engineer an intelligent sensor with antibody immobilized in a particular way such that the target biomolecule or pathogen may be selectively detected while minimizing false positives.

In another aspect, certain embodiments of the invention provide the ability to reduce the chance of biofouling of the sensor by selectively attaching antibodies. This aspect of the invention reduces the chance of cross-contamination from other pathogens since the ‘intelligent engineering’ of the sensor results in the elimination of effects of cross-contamination, since the antibody only matches the specific pathogen being investigated.

In another aspect, certain embodiments of the invention provide the ability to decode the presence of a specific pathogen by observing the optical throughput of the fiber. Another aspect of certain embodiments of the invention permits the elimination of complicated detecting schemes since the invention can work with any detector that is responsive to the wavelengths used.

In another aspect, certain embodiments of the invention involve the use of very low powered lasers for sensing, which low powered lasers will not generally damage the pathogens being detected.

In another aspect, the present invention provides the ability to increase the sensitivity of biosensors beyond the currently achieved level, from 100 femtogram/mL to less than 1 femtogram/mL, through the use longer wavelengths of 850 to 4000 nm.

There may be other aspects of this invention that are not explicitly mentioned in this section, but instead are described below.

### BRIEF DESCRIPTION OF THE DRAWINGS

FIG. 1(a) is a diagram illustrating a fiber holder of the invention.

FIG. 1(b) is a cross-sectional view of the fiber holder of FIG. 1(a).

FIG. 2(a) is a Micrograph of two tapered fibers taken using a light microscope camera.

FIG. 2(b) is a schematic representation of a tapered fiber of an embodiment according to the invention.

FIG. 3 is a depiction of an optical taper grating.

FIG. 4 depicts evanescence field strength.

FIG. 5 is a depiction of a needle catheter probe.

FIG. 6 is a depiction of an endoscope probe.

FIG. 7 is a depiction of a preferred signal circuit.

FIG. 8(a) is a depiction of a tapered fiber.

FIG. 8(b) is a depiction of preferred taper dimensions.

FIG. 9 is a depiction of the operation of the tapered fiber optic biosensor having a taper length of 700 μm and a waist diameter of 6 μm.

FIG. 10 is a graph of group index N versus wavelength.

FIG. 11 is a graph of the change in transmission of two antibody-immobilized TFOBs versus time.

FIG. 12 is a graph illustrating the response of fibers A and B to antibody immobilization in the embodiment of FIGS. 1(a)-1(b).

FIG. 13(a) is a graph illustrating bovine serum albumin (BSA) attachment and release of a 10 μg/mL sample using fiber F.

FIG. 13(b) is a graph illustrating BSA attachment and release for a 100 ng/mL sample using fiber B.

FIG. 14 is a graph illustrating attachment of a 100 pg/mL sample on fibers E and H.

FIG. 15(a) is a graph illustrating normalized transmission data in water for a short symmetric taper.

FIG. 15(b) is a graph illustrating normalized transmission data in water for longer asymmetric taper

FIG. 16(a) is a graph of normalized transmission versus wavelength illustrating the transmission characteristics of two tapers in fibers fabricated using heat drawing HD-1 whose air to water transmission ratio is near unity.

FIG. 16(b) is a graph of normalized transmission versus wavelength illustrating the transmission characteristics of two tapers in fibers fabricated using heat drawing HD-2 whose air to water transmission ratio is near unity.

FIG. 17 is a graph illustrating normalized transmission data in water at 470 nm as a function of change in waist diameter.

FIGS. 18(a) is a graph illustrating transmission characteristics of three short tapers in fibers FS-158 according to the current invention.

FIG. 18(b) is a graph illustrating transmission characteristics of three short tapers in fibers FS-164 according to the current invention.

FIG. 18(c) is a graph illustrating transmission characteristics of three short tapers in fibers FS-2 according to the current invention.

FIG. 19 is a graph illustrating normalized transmission characteristics of tapers in fibers fabricated using a Fusion Splicer at 470 nm according to the current invention.

FIG. 20(a) is a graph illustrating normalized transmission characteristics of heat-drawn tapers in fibers HD-7.

FIG. 20(b) is a graph illustrating normalized transmission characteristics of heat-drawn tapers in fibers HD-14.

FIG. 21 is a graph illustrating relative transmission response of heat-drawn tapers in fibers at 470 nm according to the current invention.

FIG. 22 depicts a tapered fiber optic biosensor (TFOB) transmission measurement experimental setup.

FIG. 23(a) is a graph of change in transmission of two antibody-immobilized TFOBs versus time. The dimensions of the TFOBs are about a=480 μm, b=213 μm, c=500 μm, d=5 μm.

FIG. 23(b) is a graph of change in transmission of two antibody-immobilized TFOBs versus time.

FIG. 24(a) is a graph of change in transmission versus time of an antibody-immobilized TFOB having dimensions of about a=400 μm, b=245 μm, c=574 μm, d=5 μm.

FIG. 24(b) is a graph of change in transmission versus time due to PBS prior to protein addition. The time scale was adjusted such that the sample addition for each solution is at time zero.

FIG. 25(a) is a graph of transmission versus time for a TFOB having dimensions of about a=360 μm, b=134 μm, c=500 μm and d=8 μm.

FIG. 25(b) is a graph of transmission versus time for a TFOB having dimensions of about a=412 μm, b=223 μm, c=522 μm and d=8 μm.

FIG. 25(c) is a graph of change in transmission of de-ionized water versus refractive index, based on the concentration of glucose in the 0.01-0.1 g/mL range.

FIG. 26 is a graph of transmission versus time for a TFOB having dimensions of about a=360 μm, b=134 μm, c=500 μm and d=8 μm.

FIG. 27(a) is a graph plotting raw data for staircase measurements of Fiber G.

FIG. 27(b) is a graph plotting data for staircase measurements of Fiber G that is normalized to the initial value.

FIG. 28(a) is a graph plotting raw data for staircase measurements of Fiber G with the sample concentration ranges from 100 fg/mL to 10 ng/mL.

FIG. 28(b) is a graph plotting data for staircase measurements of Fiber G, with the sample concentration ranges from 100 fg/mL to 10 ng/mL that is normalized to the initial value.

### DETAILED DESCRIPTION OF THE PREFERRED EMBODIMENTS

The invention is directed to a tapered fiber and to a tapered fiber optic biosensor (TFOB) including such tapered fibers, as well as to methods for detecting pathogens, proteins and DNA and measuring their concentrations at sub-nanogram per mL levels. TFOBs enable relatively simple, yet highly sensitive detection, as compared to the above-described prior art methods. One advantageous aspect of TFOBs is the interaction of the evanescent field with the analyte surrounding the tapered region of the fiber. Sensitivity depends to some extent on sample concentration but may be enhanced by increasing the strength of the evanescent field, which in turn depends on the geometry of the tapered optic fiber and application long wavelengths to increase penetration depth.

In one embodiment, the TFOB may comprise a tapered fiber, laser diodes as a light source, and one or more detectors. A biosensing system may also optionally include a sample holder to hold a sample, an insertion device to insert/inject the sample into the sample holder, a flow system which circulates the sample in the tapered waist region, a mechanism to clean the fiber in situ for reuse.

### Fabrication of a Tapered Fiber

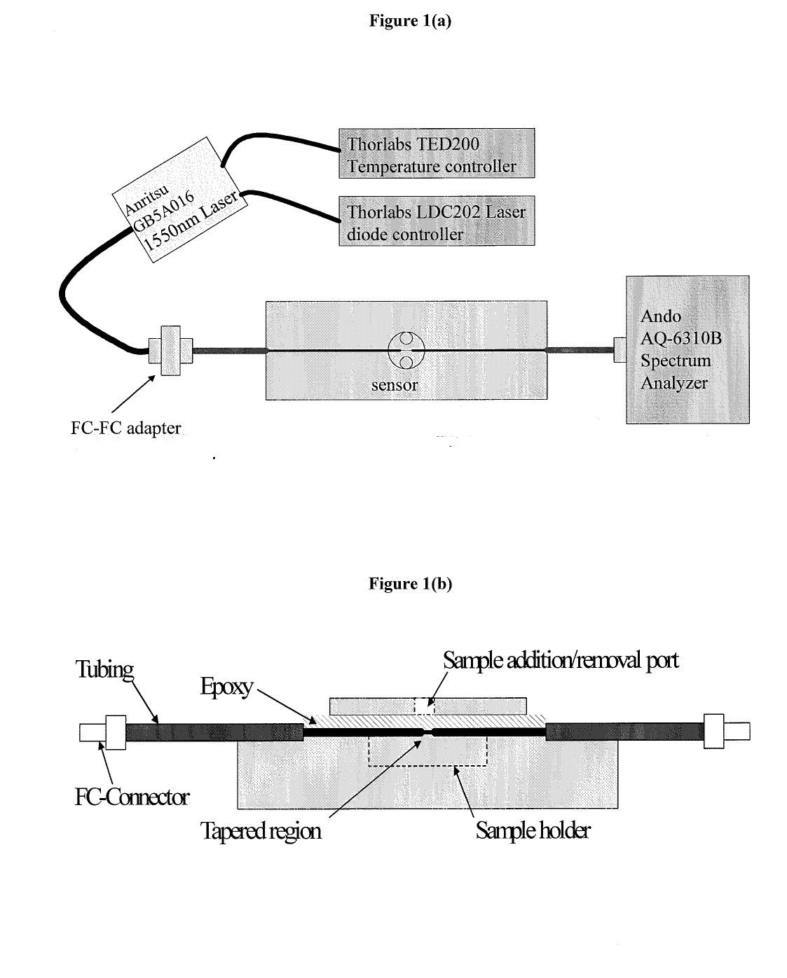

The tapered fiber may be fabricated from a silica single mode optical fiber, attached to a fiber holder and subsequently connectorized. The polymeric sheathing is first stripped from of a silica single mode optical fiber, and the fiber is immersed in acetone. A fusion splicer may then be used to incorporate tapered regions onto the fiber. An electric current may be applied to the fiber while the taper is pulled automatically. Varying the applied current and pulling time may be used to create tapers of various diameters and lengths. The fiber is then attached to a fiber holder with any standard adhesive. The fiber is subsequently connectorized by inserting protective tubing onto the fiber on both sides of the fiber holder. The protective tubing may be held in place using a standard adhesive. The ends of the fiber are connectorized and polished according to standard manufacturing practices. A cross-sectional diagram of a connectorized TFOB is shown in FIG. 1(b).

FIG. 1 depicts the resultant tapered fiber incorporated a TFOB. FIG. 1 also shows a light source, a 1550 nm DFB laser with a maximum rated output power of 20 mW and peak wavelength of 1546.4 nm. In the preferred embodiment, the laser is operated at 5 mW. A FC-FC mating sleeve connects the fiber to the light source; the other end of the fiber is connected to a spectrum analyzer. FIG. 1 also shows a 200 μL volume sample chamber. The two side ports may be used for introducing and removing samples from the TFOB. The TFOB may also be incorporated in a flow cell for improved detection capabilities.

### Tapered Fiber Geometry

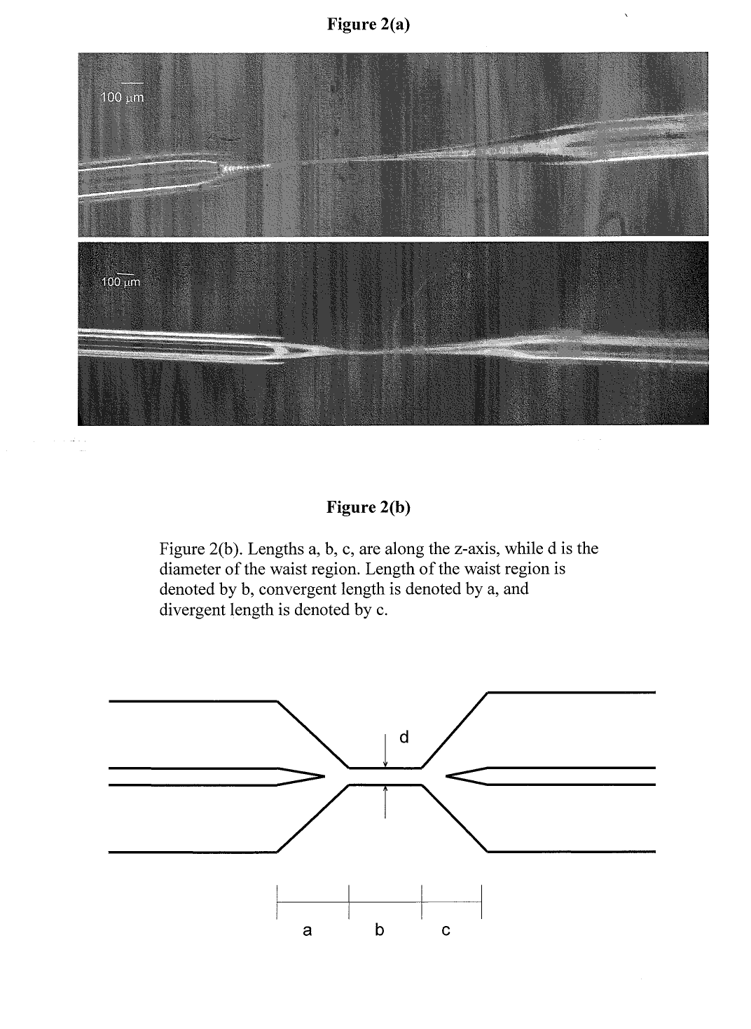

FIG. 2 shows an optical micrograph of a typical tapered fiber and a schematic representation of the geometric parameters of the taper. The convergent, divergent and waist lengths are labeled as a, b, and c, respectively. The length of the taper is designated as the sum of a, b, and c. Table 1 summarizes the optical response of eight sample tapered fibers, representing the general range of behavior of the tapered fibers.

TABLE 1

| Taper | a | B | c | d |
|---|---|---|---|---|
| Designation | μm | μm | μm | μm |
| A | 386 | 193 | 1108 | 11 |
| B | 406 | 104 | 726 | 7 |
| C | 375 | 104 | 616 | 8 |
| D | 409 | 100 | 550 | 13 |
| E | 427 | 89 | 1068 | 6 |
| F | 438 | 85 | 505 | 13 |
| G | 391 | 113 | 744 | 11 |
| H | 406 | 74 | 813 | 6 |

TABLE 2

| | Transmission | Transmission | Transmission |
|---|---|---|---|
| | Ratio | Ratio | Ratio |
| Taper | at 1550 nm | at 1550 nm | at 1550 nm |
| Designation | (PBS/air) | (post Ab/pre Ab) | (post BSA/pre BSA) |
| A | 0.46 | 0.24 | 1.07 |
| B | 1.16 | 1.97 | 0.93 |
| C | 0.20 | 0.82 | 0.88 |
| D | 2.34 | 1.5 | 0.9 |
| E | 0.29 | 1.02 | 0.86 |
| F | 0.39 | 1.96 | 0.93 |
| G | 0.88 | 0.98 | 4.5 |
| H | 39.6 | N/A | 1.29 |

The present invention may employ tapered fibers having a waist diameter in the tapered region of anywhere from about 1 μm to about 25 μm. More preferably, the waist diameter in the tapered region is from about 1 μm to about 15 μm, and most preferably, the waist diameter in the tapered region is from about 1 μm to about 7 μm. The length of the tapered region may range from about 0.1 to about 10 mm, more preferably, from about 0.5 mm to about 5 mm, and, most preferably, from about 0.6 mm to about 1.2 mm in length.

At 470 nm, depending on taper geometry, transmission increases or decreases when PBS was added due to the refractive index effect. In particular, geometric parameters such as a long length (greater than 1 mm), a small diameter (less than 7 μm), and taper asymmetry (the ratio, c/a) resulted in increased transmission in PBS. The reason why diameters less than 7 μm sometimes resulted in increased transmission in PBS is because light transmission in PBS is highly variable in that diameter range and depended very strongly on the waist diameter. If the taper diameter were larger than 7 μm, the transmission tended to depend more on the taper length. Based on this, it was expected that fibers B and H would have transmission ratios greater than one. While fiber D is similar to fiber F in dimensions, its transmission characteristics differ significantly. It is believed that the reason for these differences is the difference in the ratios of the convergent to divergent lengths of fibers D and F.

Table 3 further summarizes the physical dimensions and optical characteristics of various tapered fibers. Tapers produced by the fusion splicer are short, ranging from 0.96 to 2.48 mm. By adjusting the tension applied to one side of the fiber holder, it was possible to create asymmetric tapers varying from 0.99 to 3.74. Table 3 also describes various parameters of heat-drawn (HD) tapered fibers and fusion spliced tapered fibers.

TABLE 3

| | | | | | Trans- | | |
|---|---|---|---|---|---|---|---|
| | | | | | mission | | |
| Taper | | | | | Ratio at | | Overall |
| Desig- | a | b | c | d | 470 nm | Asymmetry | length |
| nation | μm | μm | μm | μm | (water/air) | Ratio c/a | μm |
| FS-1 | 434 | 187 | 929 | 7.9 | 0.49 | 2.14 | 1550 |
| FS-2 | 448 | 455 | 905 | 6.3 | 0.48 | 2.02 | 1807 |
| FS-3 | 344 | 198 | 1285 | 9.5 | 0.70 | 3.74 | 1826 |
| FS-4 | 394 | 505 | 1426 | 3.2 | 0.52 | 3.62 | 2324 |
| FS-41 | 390 | 275 | 668 | 14.2 | 0.74 | 1.71 | 1333 |
| FS-42 | 391 | 549 | 665 | 12.7 | 0.69 | 1.70 | 1605 |
| FS-50 | 440 | 940 | 1096 | 5.0 | 1.40 | 2.49 | 2476 |
| FS-51 | 391 | 996 | 879 | 3.2 | 1.06 | 2.25 | 2266 |
| FS-52 | 460 | 41 | 460 | 3.2 | 0.41 | 1.00 | 961 |
| FS-54 | 390 | 172 | 954 | 6.0 | 0.47 | 2.45 | 1516 |
| FS-55 | 368 | 620 | 856 | 3.0 | 1.10 | 2.33 | 1844 |
| FS-56 | 396 | 335 | 821 | 11.0 | 0.61 | 2.07 | 1552 |
| FS-158 | 461 | 82 | 470 | 9.5 | 1.23 | 1.02 | 1013 |
| FS-162 | 459 | 65 | 483 | 9.5 | 0.74 | 1.05 | 1007 |
| FS-163 | 454 | 90 | 434 | 7.9 | 0.49 | 0.96 | 978 |
| FS-164 | 463 | 57 | 457 | 4.8 | 0.49 | 0.99 | 978 |
| HD-1 | 2218 | 230 | 1910 | 24.0 | 1.02 | 0.86 | 4358 |
| HD-2 | 2273 | 763 | 1800 | 27.0 | 1.06 | 0.79 | 4836 |
| HD-3 | 3784 | 1559 | 2218 | 11.0 | 0.97 | 0.59 | 7561 |
| HD-4 | 3023 | 2514 | 1509 | 6.3 | 1.30 | 0.50 | 7046 |
| HD-5 | 2938 | 2580 | 1649 | 7.9 | 1.03 | 0.56 | 7167 |
| HD-7 | 2218 | 470 | 1129 | 14.2 | 1.28 | 0.51 | 3817 |
| HD-8 | 1109 | 2110 | 1523 | 4.8 | 1.33 | 1.37 | 4742 |
| HD-9 | 1129 | 1477 | 1481 | 7.9 | 1.04 | 1.31 | 4087 |
| HD-10 | 1074 | 1032 | 2742 | 6.3 | 1.25 | 2.55 | 4848 |
| HD-11 | 2218 | 202 | 1625 | 11.1 | 0.56 | 0.73 | 4045 |
| HD-12 | 2218 | 245 | 1354 | 11.1 | 0.87 | 0.61 | 3817 |
| HD-13 | 2218 | 1406 | 1296 | 9.5 | 0.85 | 0.58 | 4920 |
| HD-14 | 1109 | 1109 | 1769 | 20.6 | 0.86 | 1.60 | 3987 |

The foregoing tables show that sensitivity is dependent upon fiber geometry, including taper geometry, lengths of convergent and divergent sections, waist diameter and taper length. For tapered fibers with waist diameters from 6-12 μm drawn from 8 μm core/125 μm cladding with a total taper length of 600 μm to 1.2 mm, it was shown that: (1) Tapers with similar waist diameters exhibit an increase or a decrease in transmission when the taper was immersed in water from air, (2) when EC attached to the surface mediated by an antibody specific to EC, the transmission response showed an increase or a decrease, depending on the taper geometry, and (3) when EC concentration was increased, the transmission response either increased or a decreased, and depended strongly on the taper geometry used. These results indicate that the taper geometry not only affected the magnitude of sensor response, but also its direction.

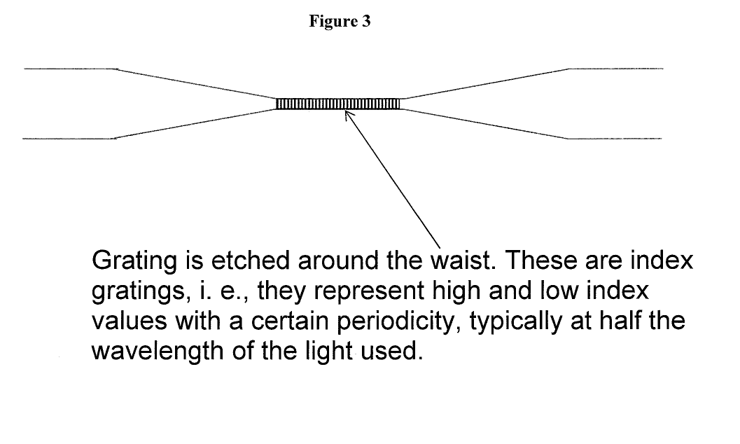

In a preferred embodiment, the tapered fiber further includes a tapered grating section that creates an optical resonator for purposes of amplifying the detection sensitivity shown in FIG. 3. The grating may be manufactured according to any standard technique such as UV lithography with a mask.

### Numerical Simulation of Light Transmission in a Tapered Fiber

For the numerical simulation of light transmission through a tapered portion, the simplified mode theory based on linearly polarized modes (LP) (Okamoto, 2000) was employed. When light is launched normal to the interface, the only modes that are excited are the LP₀ₘ modes. The transverse components of the electrical field inside the fiber are:

$${E}_{X} ( r ) = A \{ \begin{matrix}{J}_{0} ( {U}_{0 m} R ) , & R \leq 1 \\ \frac{{J}_{0} ( {U}_{0} )}{{K}_{0} ( {W}_{0} )} {K}_{0} ( {W}_{0 m} R ) , & R > 1\end{matrix} \}$$

where R is the normalized radial coordinate, r/α₀, and U and W are constants. J₀(•) and K₀(•) are the Bessel and modified Bessel functions of zero^{th} order, respectively. A is a constant determined from orthogonality principle (Okamoto, 2000). The subscript m represents the various circularly symmetric LP₀ₘ modes that can be present in the fiber. The constants U and W depend on the wavelength and refractive index of the core:

$${U}_{0 m}^{2} = {a}_{0}^{2} [ {( \frac{2 π}{λ} )}^{2} {n}_{co}^{2} - {β}_{0 m}^{2} ]$$

$${W}_{0 m}^{2} = {a}_{0}^{2} [ {β}_{0 m}^{2} - {( \frac{2 π}{λ} )}^{2} {n}_{cl}^{2} ]$$

where c is the speed of light and β is the propagation constant. When m=1, there is only the fundamental mode.

As mentioned above, in the taper region where V_{core}<1 and V_{clad}>2.405, many modes can be supported since the index difference between the cladding and the external medium (nₑₓₜ) is large. Tapering also causes coupling among modes. Radial symmetry of tapering, leads to coupling among LP₀ₘ modes. The contracting and expanding regions of the taper can be approximated using stepwise linear approximation. At the i^{th} step, the parameters U₀ₘ and W₀ₘ and are analogous to the constants U and W in a constant radius core. They can be expressed using the local radius ρⁱ as

$${U}_{0 m}^{i 2} = {ρ}^{i 2} [ {( \frac{2 π}{λ} )}^{2} {n}_{cl}^{2} - {β}_{0 m}^{i 2} ]$$

$${W}_{0 m}^{i 2} = {ρ}^{i 2} [ {β}_{0 m}^{i 2} - {( \frac{2 π}{λ} )}^{2} {n}_{ext}^{2} ]$$

The V-number for each step is given by:

$${V}^{i} = \frac{2 π}{λ} {{ρ}^{i} [ {n}_{cl}^{2} - {n}_{ext}^{2} ]}^{1 / 2}$$

The values of U, W and β can be calculated using the LP mode approximation (Okamoto, 2000). The relationship between the modal amplitudes of the LP₀ₘ modes of the i^{th} step and LP_{0q} modes of the (i+1)^{th} step is:

$${\sum }_{m = 1} {A}_{m}^{i} {E}_{m}^{i} ( r ) {e}^{- {jβ}_{m}^{i} {z}^{i}} = {\sum }_{q = 1} {B}_{q}^{i + 1} {E}_{q}^{i + 1} ( r ) {e}^{- {jα}_{q}^{i + 1} {z}^{i + 1}}$$

E(r) is the electric field, βₘ is the propagation constant on the left side of the fiber section and α_{q} is the propagation constant on the right. It is assumed that E(r) are orthonormal. That is,

∫₀^{∞}∫₀^{2π}|E(r)|²rdrdφ=1

Aₘ is the amplitude of the modes on the left side of the fiber section and B_{q} is the amplitude of the modes on the right. The amplitude on the right is obtained by applying the orthogonality principle:

$${B}_{q}^{i + 1} {e}^{- {jα}_{q}^{i + 1} {z}^{i + 1}} = {\sum }_{n} {\sum }_{m} {A}_{m}^{i} {e}^{- {jβ}_{m}^{i} {z}^{i}} {C}_{nm ; pq}$$

$${C}_{nm ; pq} = 2 π {\int }_{0}^{∞} {E}_{q}^{i + 1} ( r ) {E}_{m}^{i} ( r ) r d r$$

In the tapered region, light is coupled among the various LP₀ₘ modes. When V_{core}=1, power in the LP₀₁ cladding mode is transferred to LP₀₁ core mode and appears at the output end of the fiber. The light remaining in other modes stays in the cladding and is lost. Parameters such as taper geometry, wavelength and number of steps were systematically varied, and the resulting changes in power transmission were calculated using a MATLAB® program.

### Antibody Immobilization

Antibodies may be immobilized on the tapered fiber using a standard bioconjugate technique or other known methods for binding an antibody to an optical fiber. The TFOB may then be exposed to a sample to bind and detect the presence of a specific antigen. Upon binding, the fiber surface increases in diameter, increasing the transmission of light. A change in refractive index due to antibody immobilization may also lead to increased or decreased transmission.

It is further contemplated that the by orienting the antibodies on the sensors during the immobilization procedure, it may be possible to further enhance detection sensitivity. In a preferred embodiment, the tapered fiber is coated with gold for purposes of orienting the antigen-binding sites toward the analyte. The sensitivity of immunosensors can be improved by maximizing the degree of functional orientation of the active sites and minimizing the size of antigen-binding molecules, so as to create a dense receptor layer.

### Kinetics of Antigen Attachment to Antibody-Immobilized TFOB

It is possible to estimate and model the kinetics of antibody immobilization and protein attachment on antibody-immobilized surfaces. The immobilization and detection responses show exponential behavior, similar to the adsorption process often referred to as Langmuir kinetics. The Langmuir kinetics model can be expressed as:

θ=1−e^{-k}^{_{obs}}^{t}

where θ(0≦θ≦1) is the fractional coverage of the reactive sites, the NH₂ groups on the fiber surface or immobilized antibody at time, t. The parameter, k_{obs}, is the observed binding rate constant, which depends on the bulk concentration of the reactant. We hypothesize that the measured transmission is indicative of the antibody or BSA attachment, and therefore express the Langmuir model as follows:

(ΔI)=(ΔI_{∞})(1−e^{-k}^{_{obs}}^{t})

where (ΔI) is the change in transmission at time, t, and (ΔI_{∞}) is the steady state transmission change. Taking the natural log on both sides we obtain:

$$ln ( \frac{( Δ {I}_{∞} ) - ( Δ I )}{( Δ {I}_{∞} )} ) = - {k}_{obs} t$$

The above suggests that the characteristic rate constant k_{obs} during initial time can be determined from a plot of the left hand side versus t including only data obtained during the first few minutes, when bulk concentration is nearly constant.

### Effect of Concentration on Refractive Index

Detection sensitivity obviously increases with sample concentration. The present invention, however, is advantageous in that it is capable of detection at sample concentrations of less than 10 pg/mL and has been shown to detect sample concentrations of about 10 fg/mL. The invention is also capable of detection at concentrations lower than 10 fg/mL.

There are two components that contribute to the change in refractive index, ΔN. The first component is the change in index in the bulk fluid, Δn_{c}. The second component is the change in index due to adsorption of molecules on the surface of the optical component. For a thickness of the adsorbed layer, d_{f}, ΔN is given by:

$$Δ N = ( \frac{\partial N}{\partial {d}_{f}} ) {d}_{f} + ( \frac{\partial N}{\partial {n}_{c}} ) Δ {n}_{c}$$

To obtain an estimate of the changes in the bulk refractive index Δn_{c} of a BSA solution, one could use the relationship:

$${n}_{c} = {n}_{m} + c ( \frac{d n}{d c} ) ( 0.94 + \frac{0.02}{{λ}^{2}} )$$

where nₘ is the refractive index of the medium, c is the concentration, and λ is the wavelength in nm. The refractive index of PBS, the medium, is:

$${n}_{m} = 1.3242 + \frac{0.00287}{{λ}^{2}}$$

At λ=1510 nm, nₘ is 1.3242. The term

$$\frac{d n}{d c}$$

is the rate of change of refractive index with concentration, and was determined to be in the range of 100 to 1200 mg/dL. By extrapolation, the value of

$$\frac{d n}{d c}$$

for BSA is 1.8×10⁻¹³ mL/pg, assuming linear behavior at lower BSA concentrations. In Eq.(8) the λ-term is negligible compared to 0.94, and hence the refractive index of the BSA solution is

n_{c}=1.3242+1.7×10⁻¹³c

and,

Δn_{c}=1.7×10⁻¹³Δc

The above indicates that at BSA concentrations of 10 pg/mL, the expected change in n_{c} is essentially zero. Thus, the change in transmission is due to the change in refractive index that occurs due to surface attachment. TFOBs with waist diameters of 7 to 12 μm and taper lengths of 1 mm exhibited strong transmission changes when antibody binds to the surface and when the antigen (BSA) binds to the antibody at 1550 nm. Because the interaction with the evanescent field increases as the distance to the fiber surface decreases, the changes were much larger when antibody was immobilized than when the antigen binding occurred. The limit of detection of BSA was found to be 100 fg/mL. There is an inverse dependence of change in transmission with antigen concentration. The response of TFOB in the preferred embodiment was found to be about one hour for antibody immobilization, and about 30 minutes for the antigen binding.

### Physics of Sensing

Optical fibers are cylindrical waveguides with an inner core typically made of Ge-doped silica and surrounded by cladding of pure silica which has a slightly lower refractive index than the core. Light propagating through optical fibers has two components: the guided component in the core, and an exponentially decaying or evanescent component in the cladding. In a regular fiber, the evanescent field decays to almost zero at the fiber surface due to the 125 μm thick cladding. However, if the fiber is tapered to a few microns, the light is no longer guided by the core but is guided by the cladding, and the evanescent field becomes prominent in the region surrounding the cladding. When a liquid medium is placed around that cladding, the evanescent field interacts with the medium through mechanisms of absorption, change in index, or scattering. An important characteristic of the evanescent field which determines the sensor sensitivity is the penetration depth given by:

$${d}_{p} = \frac{λ}{2 π \sqrt{{n}_{co}^{2} {sin}^{2} θ - {n}_{cl}^{2}}}$$

where λ is the wavelength and θ is the angle of incidence of the light at the core/cladding interface. The terms n_{co} and n_{cl} are the refractive indices (RI) of the core and cladding.

Because refractive index is a strong function of concentration, one can determine the concentration from the transmission changes. The amount of attenuation depends not only on refractive index, but also on the fraction of total light present in the evanescent field. If the evanescent field is weak, any changes due to scattering and refractive index changes would be small and difficult to detect. In addition, the penetration depth is important because a larger penetration depth ensures that the evanescent field interacts with sample farther away from the fiber surface. This may be important in certain embodiments because the surface of the fiber is modified with an antibody, meaning that the antigen does not bind directly to the surface of the fiber. The penetration depth is directly proportional to the wavelength. With the evanescent field already enhanced by tapering, it is now desirable to increase the penetration depth by increasing the wavelength for sensing.

Tapered fibers are fabricated by applying heat to a short length of the fiber as it is being pulled. Without tapering, the total diameter of a fiber may be, for example, 125 μm. After heating and pulling the tapered region of this fiber had a diameter of 3 to 20 μm. Given a wavelength of greater than 1310 mn, light propagates in single mode fibers in the lowest order (fundamental) mode as long as the radius of the core remains constant. The number of modes that propagate in a fiber is determined by the V number given by

$$V = \frac{2 π a}{λ} \sqrt{{n}_{co}^{2} - {n}_{cl}^{2}}$$

where a is the radius of the core. When V=2.405, only the lowest order mode can be supported, and as V increases, more modes are supported. Conditions of fundamental mode propagation exist until the tapering reduces the diameter, and consequently the V value to unity. When V<1, the core is too small to contain the light, and light would propagate in what was originally cladding that now serves as the core, with the external medium serving the cladding function. In such a situation, light guidance is determined by V_{clad}:

$${V}_{clad} = \frac{2 πρ ( z )}{λ} \sqrt{{n}_{cl}^{2} - {n}_{ext}^{2}}$$

where ρ(z) is the radius of the fiber as a function of distance z (parallel to the axis of the fiber) and nₑₓₜ is the refractive index of the medium surrounding the fiber. The gradual decrease in radius of the fiber leads to coupling of the lowest order mode to several higher order modes in the tapered region. Higher order modes have a larger fraction of power in the evanescent field.

The sensitivity of TFOB depends on the surface concentration of the antibody and the strength of evanescent field. One method for increasing the evanescent field strength is to alter the geometry of the fiber. Sensitivity is enhanced when the radius is less than 7 μm, lengths are greater than 1 mm and asymmetry of the convergent and divergent sections are present.

Another method of increasing the evanescent field strength is to use longer wavelengths because the penetration depth increases with wavelength. At longer wavelengths, waist diameters in the range of 8 to 12 μm produce sufficient evanescent field for detection. Another significant advantage of longer wavelength is the availability of stable, low cost lasers and detectors, particularly in the 1500 nm range, used commonly in telecommunications. These long wavelength sensors are capable of being mass produced and are less expensive in comparison to standard ultra violet or telecommunication materials.

The present invention may employ wavelengths of from about 850 nm to about 4000 nm. More preferably, wavelengths of 1100 nm to about 2500 nm are employed. Most preferably, wavelengths of 1300-1800 nm are used. To our knowledge no work has been reported using long wavelengths in the context of tapered fibers. The transmission in tapered fibers is extremely sensitive to protein concentration with long wavelengths. The power levels are in the microwatt range in some embodiments of the invention as compared to prior art which used high power levels in order to excite two or three photon mechanisms to accomplish sensing.

### Tapered Fiber Applications

The TFOB may be further reduced in size and integrated into various testing devices such as glucose strips, pregnancy kits or other test for detecting a specific biomarker, such as a pathogen or toxic agent. The TFOB may also be incorporated in a microchip and used in MEMS devices. The small size of the sensor enables creation of a portable biosensor that may be disposable, eliminating any issue of contamination due to repeated usage.

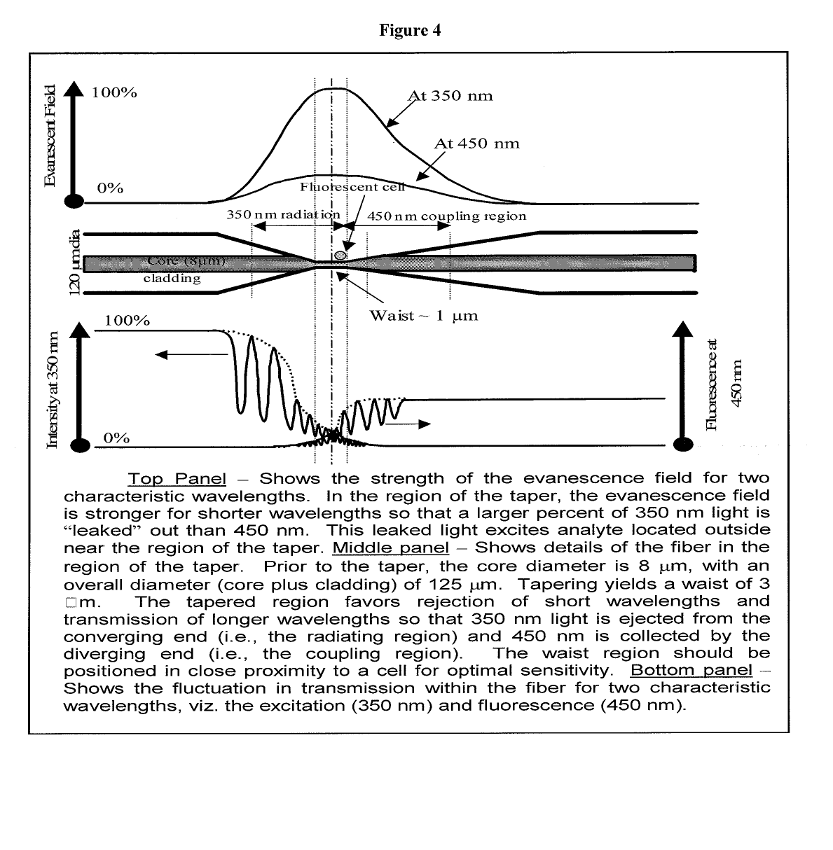

In one embodiment, the TFOB may be used to create an optical biopsy probe based on fluorescence lifetime analysis for the detection and classification of malignant tissue growths. The tapered optical fibers may be used as a delivery device for the excitation light and to collect the fluorescence emission in situ. Utilizing the dispersive property of the optical fibers, the excitation and emission pulses will be separated temporally to measure directly the rise and fall times of the fluorescence emission and the delay of the emission pulse (dynamic fluorescence response) without the current approach of estimating them by complex (and often) arbitrary signal processing methods. This approach, shown in FIG. 4, is advantageous in its ability to simplify measurements and produce more accurate data. In addition when excitation and emission wavelengths are close or if the sample is heterogeneous (i.e. very short lifetimes), the excitation and emission pulses can be separated with less measurement errors. This probe may be particularly beneficial to the detection and diagnosis of cancer and other classic malignancies. Because the probe does not depend on the concentration of the fluorophore it is possible to obtain lifetime information even when the cancer cells are at the very early stage of growth, allowing for the potential for early cancer detection. The probe may be particularly useful in differentiating malignant tissue from normal ones and to enable direct optical biopsy without the need for the physical removal of tissue by incorporating the probe in medical devices such as endoscopes and catheters to determine the presence of a biomarker in situ.

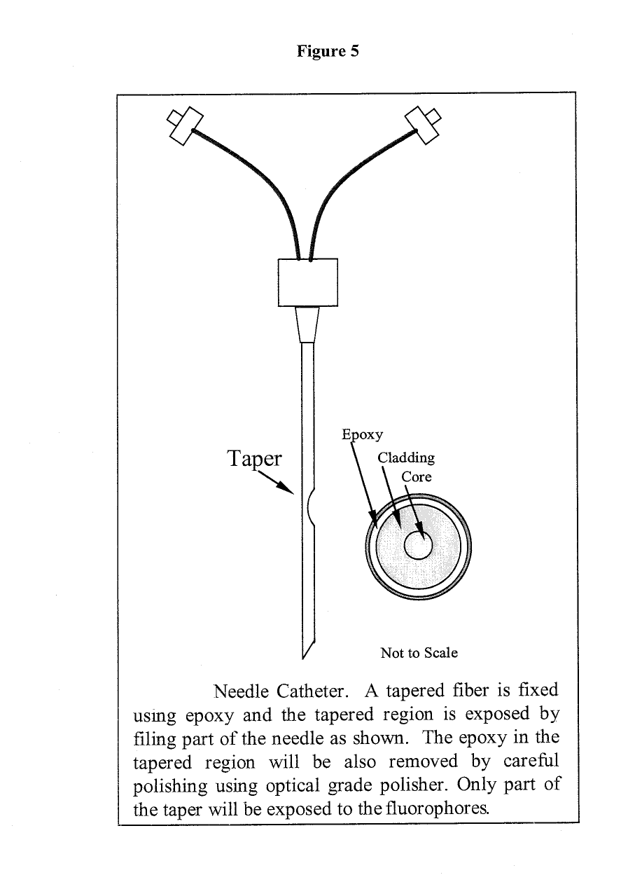

For example, a polished tapered fiber may be epoxied into a gage needle, wherein the needle will be partially filed in the tapered region (see FIG. 5) to expose the taper region. Such a device may allow physicians to more quickly access the formation of biofilms signaling the onset of an infection.

For incorporation in an endoscope, the probe should be accessible from a single end, that is, the launching of the emission and the collection of the excitation pulses should take place at the same end. Additionally, the sensing region, i.e., the region of the probe exposed to the sample must be small and isolated making it possible to explore different parts of the inside of the human body.

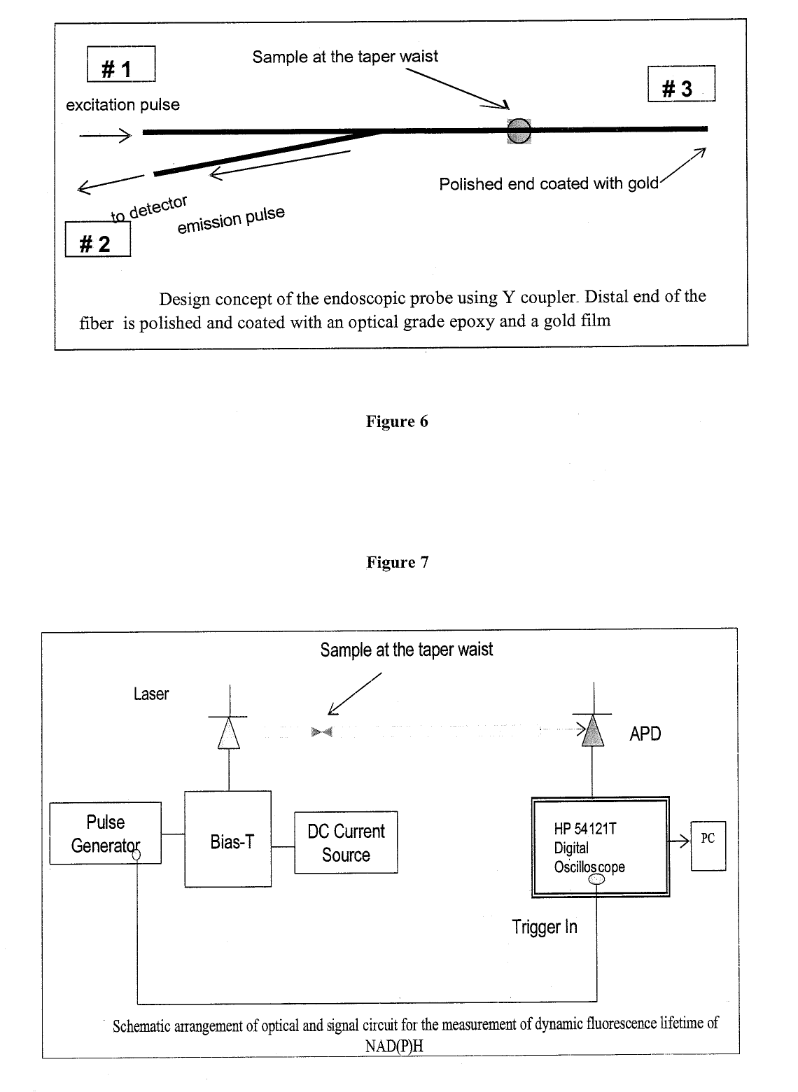

This will be accomplished using a 2×1 Y coupler as shown in FIG. 6. The excitation light enters the coupler through port #1. The single fiber on the other side contains the tapered region and the sample. Port #3 is polished and coated with a fine gold film to enhance the reflection back to the fiber which is recovered in Port #2, thus completing a loop with transmission and reception on the same side. This enables the probe to a part of an endoscope which can be inserted into the body, with the tapered region exposed to the tissue being examined. The terminals #1 and #2 will be part of the endoscope (Front end). Terminal #1 will be connected using an FC connector to the source (Pulse Laser diode) and terminal #2 will be connected to a photodetector. The rest of the signal processing system will be identical to the one shown in FIG. 7. The sensitivity analysis of the Y coupler geometry is done including the additional losses introduced by the coupler (Table 5(a) and 5(b)).

TABLE 5a
The sensitivity of the taper fiber geometry.

| Description | Parameters | Quantity | Power Values (mW) |
|---|---|---|---|
| Peak Laser Power | 400 | input power | 400 |
| (P mW) rated @ 400 mW | | | |
| Coupling efficiency to | 70 | power into the fiber | 280 |
| the tapered fiber (%) | | | |
| Evanescent field | 70 | power outside the fiber | 196 |
| (excitation) outside (%) | | waist | |
| Fluorescence emission | 0.8 | power of the fluorescence | 1.568 |
| yield (%) | | signal | |
| Fluorescence emission | 10 | power (fluorescence) | 0.157 |
| coupled back (%) | | coupled back into the fiber | |
| Loss in 2 m fiber (worst | 0.4 | power after 2 m long fiber | 0.143 |
| case @ 200 dB/Km) dB | | | |
| Coupling loss (detector) dB | 3 | power at the receiver | 0.071 |
| Losses from other causes | 1 | power at the receiver | 0.057 |
| (dB) | | including other losses (P_{R} mW) | |
| pulse width FWHM(ps) | 70 | input pulse width | |
| PRF (MHz) | 40 | pulse repetition rate | |
| Average power incident on | | power (P_{R}) × pulse | 0.00016 |
| the detector Pₐᵥ | | width × PRF | |
| | | | Power (dBm) |
| Average power Pₐᵥ(dBm) | | | −38.0 |
| For the Y coupler | | | |
| Additional loss (dB) | 6 | | |
| Power at the detector | | | −44.0 |
| (dBm) | | | |

The fiber used was a SM UV fiber by StockerYale NUV-320-K1 or Corning PM 480, with an attenuation of 100-200 dB/Km; Picoquant LD with a coupled power of 400 mW, a pulse width of 70 ps and a PRF of 40 MHz. The detector was the NewFocus 1454 detector. Fluorescence yield was 0.8%.

TABLE 5b
The sensitivity of the tapered fiber geometry (worst case scenario).

| Description | Parameters | Quantity | Power Values (mW) |
|---|---|---|---|
| Peak Laser Power (P mW) | 400 | input power | 400 |
| rated @ 400 mW | | | |
| Coupling efficiency to the | 70 | Power into the fiber | 280 |
| tapered fiber (%) | | | |
| Evanescent field (excitation) | 50 | power outside the fiber | 140 |
| outside (%) | | waist | |
| Fluorescence emission yield | 0.5 | power of the fluorescence | 0.7 |
| (%) | | signal | |
| Fluorescence emission | 5 | power (fluorescence) | 0.035 |
| coupled back (%) | | coupled back into the | |
| | | fiber | |
| Loss in 2 m fiber (worst | 0.4 | power after 2 m long | 0.032 |
| case @ 200 dB/Km) dB | | fiber | |
| Coupling loss (detector) dB | 3 | Power at the receiver | 0.016 |
| Losses from other causes | 1 | power at the receiver | 0.0127 |
| (dB) | | including other losses (P_{R} mW) | |
| pulse width FWHM(ps) | 70 | input pulse width | |
| PRF (MHz) | 40 | pulse repetition rate | |
| Average power incident on | | power (P_{R}) × pulse | 3.56E−05 |
| the detector Pₐᵥ | | width × PRF | |
| | | | Power (dBm) |
| Average power Pₐᵥ(dBm) | | | −44.5 |
| For the Y coupler | | | |
| Additional loss (dB) | 6 | | |
| Power at the detector (dBm) | | | −50.5 |

The fiber used was a SM UV fiber by StockerYale NUV-320-K1 or Corning PM 480, with an attenuation of 100-200 dB/Km; Picoquant LD with a coupled power of 400 mW, a pulse width of 70 ps and a PRF of 40 MHz. The detector was the NewFocus 1454 detector. Fluorescence yield was = 0.5% (0.8% in Table 5a) Evanescent field outside = 50% (70% in Table 5a) Fluorescent emission coupled back = 5% (10% in Table 5a).

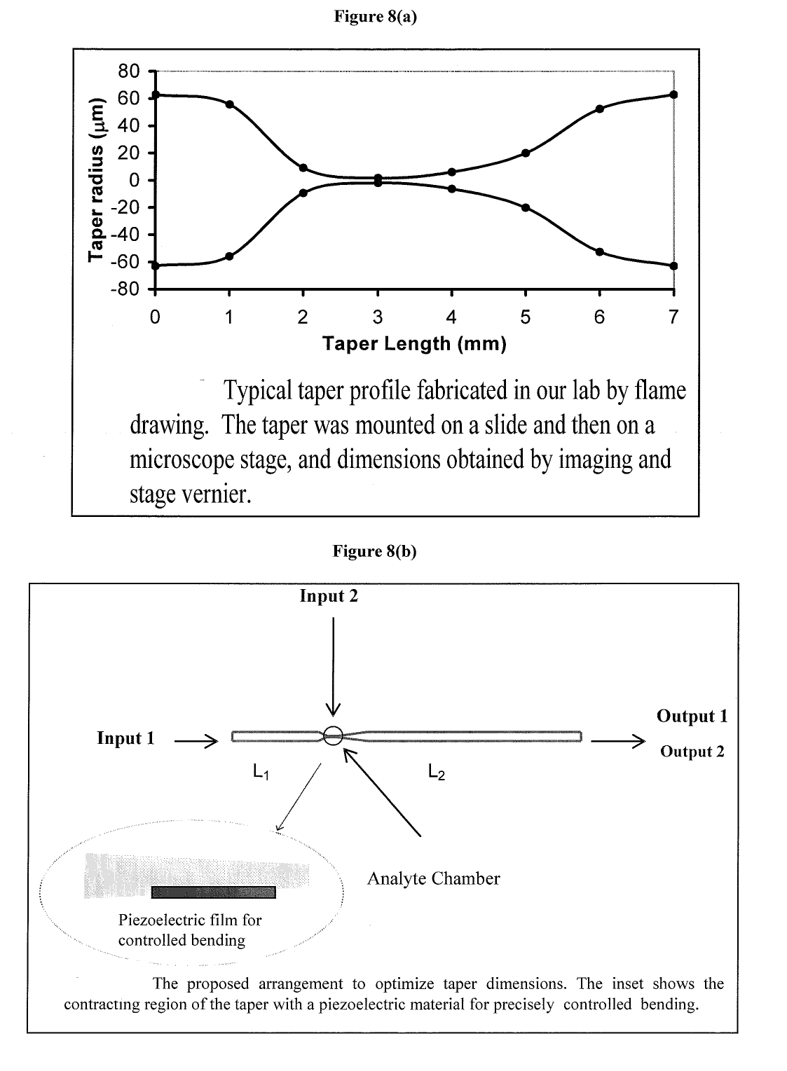

A tapered fiber assembly capable of picking up the fluorescence emission pulse and separating the emission and excitation pulses may be fabricated so that the evanescent coupling around the waist should be able to deliver the maximum amount of the excitation signal to the sample outside. Since the excitation signal is in the UV range (350-450 nm) the smallest possible diameter of the taper waist must be realized. Preferably, the diameter should be 6-8 times the wavelength and therefore on the order of about 2-3 μm. The tapers should be asymmetrical so that the expanding and contracting regions of the taper will be different. For the efficient delivery of the excitation signal to the regions surrounding the waist, the contracting side of the taper should be sharp or abrupt, as shown in FIG. 8(a), while for an efficient collection of the emission signal, the expanding side of the taper must be a relatively smooth one. The tapers may be fabricated in a one or two step process, wherein a taper is fabricated with waist diameters of about 8-10 μm using a heat pulled assembly and subsequently placed in the fusion splicer to further reduce the waist size. The taper should deliver at least more than 90% of the excitation signal outside the waist region to allow for sufficient excitation energy for absorption by the sample for the generation of fluorescence and reduction in the energy/power in excitation trace that will propagate along with the fluorescence emission signal in the fiber to the receiver.

The optimization procedure comprises launching light from a blue LD into a taper and the amount of light at the output (#1) of FIG. 8(b). This should be as low as possible. Next, a green LD is used to inject light into the taper waist, simulating a long wavelength fluorescence emission generated by the sample. The output (#2) at the end of the taper is measured at this (green) wavelength. The waist will be surrounded by water which does not exhibit any fluorescence. For the efficient operation of the taper sensor, such that output #2>>output #1. This ensures an almost complete ejection of excitation light at the waist for fluorescence generation and a significant degree of coupling of the expected emission signal back into the fiber.

Once the taper was been optimized to generate the emission signal of sufficient strength, the next step is the optimization of the length L₂ of FIG. 8(b) to produce a separation between the emission and excitation pulses at the output end. While higher value of L₂ result in greater and greater separation between the two pulses, they result in weaker and weaker emission signals at the output end due to the very high attenuation in pure silica fibers at short wavelengths. Optimization will be achieved by introducing a reproducible bend in the fiber which increases the evanescent field. This is shown in FIG. 8(b).

Nanosecond pulses will be launched from high speed LDs (manufactured by PiLas or PicoQuant) in the wavelength range of 350-500 nm from the input end of the taper. These LDs typically have a full width at half maximum (FWHM) of about 5-10 nm. Since L₁ is typically less than a few centimeters, the main delay will be produced by the length L₂ which will be in meters (see FIG. 8(b)). They will be used to launch pulses from the input end of the taper. The output pulses will be picked by a high speed photodetector (NewFocus) and displayed on the scope along with the transmitted pulses to estimate the delay generated by the fibers. The proposed experimental arrangement is shown in FIG. 7.

The estimation of delay for the fiber is essential because of the variation in index and the consequent change in group index caused by the change in the concentration of dopants used to increase or decrease the index to form the core and cladding materials.

Using a fiber that is single mode at 350 mn (SM UV fiber by StockerYale NUV-320-K1 or Corning PM 480), pulse broadening and differential delay observed in the system will be due to chromatic dispersion only. Since the fiber is single mode at the excitation wavelength, it will always be single mode at the emission wavelengths (longer than the excitation).

Without being bound by theory, it appears that this tapered fiber can both deliver the excitation signal to the tissue sample and collect the fluorescence emission to a photodetector through the same fiber without a physical break in the fiber; the fiber will separate the excitation and emission pulses by virtue of its dispersive behavior, allowing the direct measurement of the fluorescence lifetime of the sample. The probe is also capable of recovery of the emission pulse with no overlap from any remaining or trace emission pulse that propagates through the fiber.

The tapered fiber acts as a wavelength dependent delay line to produce differential delays in the two pulses, the emission and the excitation, which leads to a temporal separation of the pulses. The temporal separation enables clear resolution of the pulses. This is an important step because the trace pulse may be stronger than the emission pulse and without the ability to separate the pulses in the time domain, it may not be possible to recover the characteristics of the emission pulse. The concept of introducing a delay between the two pulses is a significant innovation and an important development in fluorescence lifetime spectroscopy, since it eliminates the need for error-prone signal processing techniques currently used in state of the art instruments. Table 4 compares the existing prior art methods (Pradhan et al. 1995; Mycek et al. 1998; Glanzmann et al. 1999; Fang et Al. 2004) with that of the present invention.

If the tapered region contains fluorescent molecules, the light present in that region is absorbed generating the longer wavelength emissions. Tapered fibers can collect the longer wavelength emission and transmit it to the distal end of the fiber. This unique property, namely, the ability to deliver short wavelength radiation to a small region outside the fiber, and to accept the resulting longer wavelength radiation and subsequent transmission through the fiber is associated only with tapers. It is this continuous geometry that provides optical robustness to the sensor. If two separate fibers had been used (or a fiber and a beam splitter), it would have resulted in errors that arise from the relative motion of the two fibers leading to loss of robustness (See Table 4).

TABLE 4
Comparison of the proposed methods and the current state-of-the art

| Property | Proposed Method | Current methods employing fibers |
|---|---|---|
| Capability for | Localized. Both delivery and reception is | Use of a two fiber geometry or a single |
| localization | localized to tapered region | fiber geometry with tips results in loss of |
| | | ability to localize |
| Robustness | Use of the same fiber (taper for delivery | No; Two fibers or One fiber and a lens |
| | and reception) makes the system very robust. | assembly to collect the emission or one |
| | | fiber and a beam splitter to recover the |
| | | emission. |
| Active or passive | Active. The full optical properties of the | Passive; Optical fibers are used as light |
| | fiber and taper are used. The sensor can | guides. |
| | therefore be engineered to enhance | |
| | sensitivity. | |
| Sub nanosecond | Easily accomplished | Error prone |
| lifetimes | | |
| Simplicity in | Same fiber is used to transmit excitation | Separation of the excitation trace and |
| fluorescence | and emission signal. Dispersion in fibers is | emission is done based on a mathematical |
| lifetime | used to produce temporal resolution and | model of decay and not on actual |
| measurement. | thus improved measurement results from | measurement |
| | the recovery of the complete emission | |
| | pulse | |

The lengths of the expanding and contracting regions, waist, and the waist diameter critically affect the performance of the tapered fiber sensors. As the waist diameter decreases, light moves from being guided to being evanescent. If light of wavelength of λ, is used the waist diameter should be on the order of 2-3 times (or, preferably less than) λ. Since many of the biomolecules exhibit fluorescence in the UV range, the diameter of the taper should be in the range of 1-2 μm to achieve high sensitivities.

The concept described above is illustrated in FIG. 4 for NADH sensing. NADH absorbs at 350 nm and has a broad emission peak at 450 mn. The taper can launch the 350 nm (or any other wavelength) excitation light in the waist region. The waist region contains cells or NADH that is to be analyzed. The longer wavelength emission (450 nm, or any other wavelength generated) is coupled back to the fiber and measured by a light sensor at the output end. The bottom portion of FIG. 4 illustrates the physical mechanism of the taper. As the fiber diameter decreases in the tapered region, light moves from the core to the outside. When the overall diameter is 1/1^{th} to 1/20^{th} of the original diameter, the light is mostly outside the waist region.

Once the emission signal is generated by fluorescence, the response is transmitted by the fiber to the receiver. However, such a geometry and concept will not be sufficient for applications involving time delay fluorescence lifetime spectroscopy. There should be a mechanism to recover the emission pulse information. That would require that a delay be introduced between the unleaked excitation pulse and the information bearing emission pulse. The principle of this approach is described below.

Consider a short pulse of an excitation beam, eₓ(t), launched into the fiber. When this light reaches the taper waist, the evanescent field interacts with the sample producing the emission pulse eₘ(t). The relation between emission and excitation pulses is

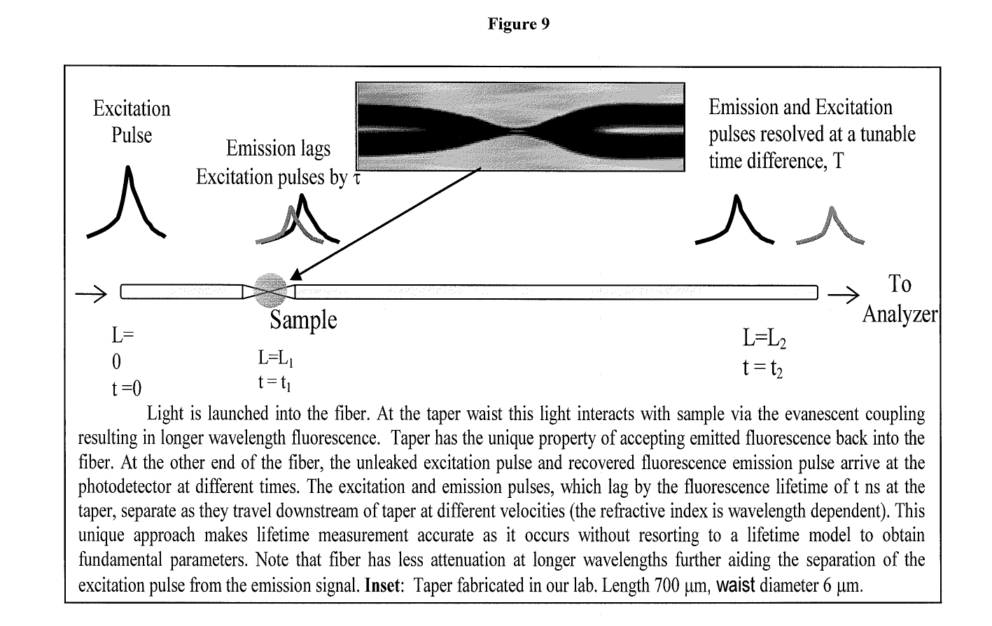

eₘ(t)=eₓ(t)*hₛ(t)

where hₛ(t) is the impulse response of the sample. Note that this equation accounts only for the pulse shapes and it is understood that the excitation and emission pulses are at different wavelengths. Assume that T_{w} represents the width of the excitation pulse. The sample reshapes the emission pulse with a decay characteristic of the analyte. We will assume that this change in shape of the emission pulse is equivalent to a small delay (t_{d}) introduced between the pulses as shown in FIG. 9 and a specific lifetime. Since T_{w}>>t_{d}, these two pulses will not be temporally resolvable enough to estimate the relative delay and correlate the delays with the properties of the analyte.

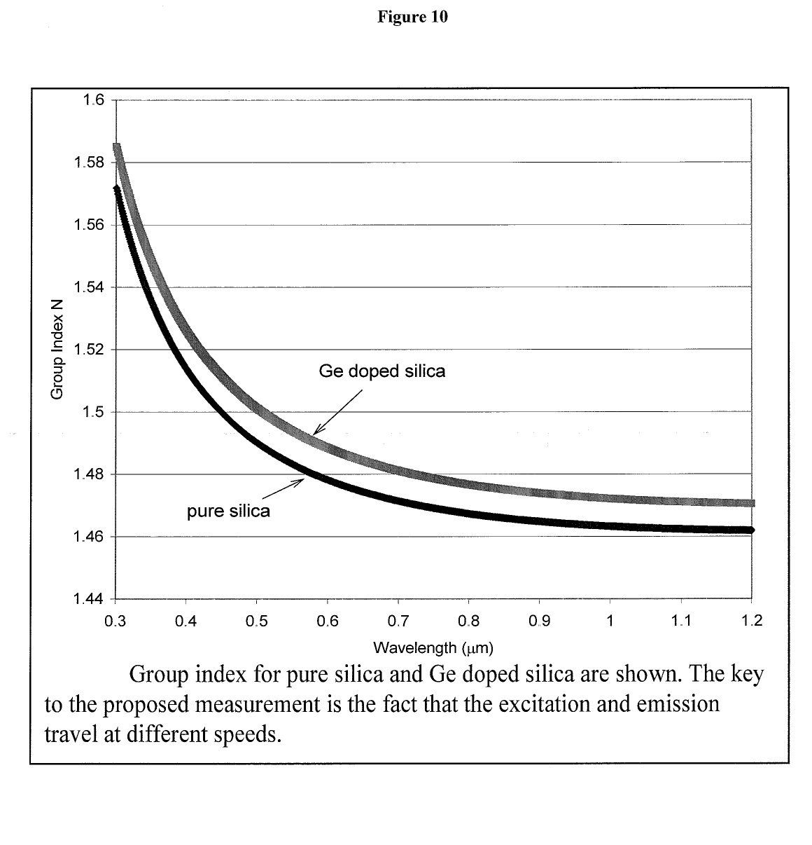

On the other hand, if the length of the fiber beyond the taper waist is long enough, one can separate the excitation pulse and the fluorescence emission pulse. The refractive index (n) of glass decreases as the wavelength increases. It varies from about 1.53 at low wavelengths to about 1.455 around 1 μm. While the refractive index provides general idea of light transmission characteristics, the information transmission properties of the fiber are described using the group velocity determined by the Group Index denoted by N. Group index N (FIG. 10) can be expressed as

$$N = n - λ \frac{d n}{d λ} .$$

The Group Index reaches a minimum (inflection point around 1200 nm; not shown in the figure) and then increases. This means that on the left side of the inflection point (wavelengths of interest in this research), the group index decreases as the wavelength increases. This would mean that the longer wavelength emission pulse will overtake the shorter wavelength excitation pulse as these pulses travel through the fiber. Note that this is true even though the longer wavelength pulse is delayed relative to the short wavelength pulse at t=t1 shown in FIG. 9. Thus, material dispersion becomes a valuable property in fluorescence lifetime measurements in separating the two pulses.

As an example, let us assume that the excitation is 350 nm and the emission is 450 nm. Let the excitation pulse duration be 70 ps. For reasonably good resolvable measurements, the time delay between the two pulses should be preferably 70 ps or longer. Typically, the group index at low wavelengths is about 1.5 in pure silica with a differential of ˜0.037 in group index from 350 to 450 nm. The time taken by the wave to move through the fiber will be determined by the group velocity ν_{g},

$${v}_{g} = \frac{c}{N} m \text{/} s$$

where c is the velocity of the electromagnetic wave in free space and N is the group index. The delay differences between the pulses (per unit length) traveling at 350 nm and 450 nm will be will be

$$τ = \vert {τ}_{350} - {τ}_{450} \vert = \frac{{N}_{350} - {N}_{450}}{c} = \frac{0.037}{3 \times {10}^{8}} = 0.1233 ns \text{/} m$$

where the velocity in free space is taken to be 3×10⁸ m/s.

These values indicate that a fiber one meter long will result in a delay of more than 100 ps, which will be adequate for resolving (separating) the two pulses. Thus, the total length of the fiber sensor will be manageable. The attenuation in pure silica fibers at short wavelengths is significant, i.e., about 80-100 dB/Km. But, over a length of 1 m, the loss will be around a 0.1 dB (almost negligible). We believe that it will be possible to recover the signal using a good APD. A further significant advantage of our approach is shorter the lifetime, the shorter the length of the fiber. Thus, sub-nanosecond responses can be easily resolved and characterized.

### EXAMPLES

### Example 1

Evanescent field sensing of the pathogen E. coli 0157:H7 was achieved using tapered fibers at 470 nm. The surface of the tapered portion was immobilized with an antibody to E. coli 0157:H7 and was then successfully used to detect E. coli 0157:H7 at a concentration of 70 cells/mL. Similar experiments were conducted with Bovine Serum Albumin (BSA) using the same light source. Instead of using anti-E. coli 0157:H7, anti-BSA was used to modify the fiber surface. Similar to E. coli 0157:H7, it was found that the attachment of BSA resulted in a detectable change in transmission.

### Example 2

The absorption of BSA was measured in a cuvette using the same 1550 nm laser that was used in the taper detection measurements in the preferred embodiment. A single mode FC fiber was used to connect the laser diode to the input of the cuvette holder (Ocean Optics, FL). Another FC fiber was connected from the output end of the cuvette holder to the same spectrum analyzer as the one used in the preferred embodiment. Transmission characteristics of various BSA solutions, made by serial dilution in the concentration range of 10 pg/mL to 1 mg/mL, were measured. In a similar way absorption of antibody to BSA at a concentration of 500 μg/mL was also determined.

### Example 3

A BSA stock solution (1 mg/mL) was prepared in 10 mM phosphate buffered saline, pH 7.4 (PBS). Lower concentrations (1 μg/mL, 100 ng/mL, 10 ng/mL, 1 ng/mL, 100 pg/mL, 10 pg/mL, 1 pg/mL, 100 fg/mL) were prepared in PBS (pH 7.4) by serial dilution. 200 μL of each BSA sample were pipetted into the sample chamber in the fiber holder of the preferred embodiment for submerging the taper. After recording the transmission during the attachment of BSA to the optical fiber in the preferred embodiment, the sample was removed by pipetting. The fiber holder and the taper were rinsed several times with PBS, and the taper was then submerged with PBS buffer, adjusted to pH 2 by sulfuric acid, to measure antigen release response. The multiple-step detection was performed on fiber G with up to six different solutions of BSA, whose concentrations ranged from 100 fg/mL to 10 ng/mL. The BSA solutions were added in order from the lowest to the highest concentration. Data were recorded by for up to 40 minutes for each solution. Each addition was preceded by removal of the previous sample. Release buffer was not used between samples.

### Example 4

The tapered fiber of the present invention may be fabricated from a silica single mode optical fiber according to the following method.

The TFOB silica single mode optical fiber (Corning Glass Works, NY, attenuation at 1300 and 1500 nm of 0.36 and 0.26 dB/m, respectively), with a core diameter of 8 μm and an overall diameter of 125 μm, was used to fabricate the tapered fiber. The polymeric sheathing was completely removed over a 5 cm long surface using a wire stripper and then immersed for 10-minutes in acetone. The tapers were created with a fusion splicer by applying an electric current via a pair of electrodes for up to 60 seconds while the fiber was pulled automatically. Current levels of 3 mA to 13 mA and pulling times of 2 sec to 11 sec were used to produce tapers of varying taper diameters and lengths.

The tapered fiber was then attached to a fiber holder by fixing the fiber with epoxy (Cotronics, NY) between two pieces of Plexiglas. The thicker piece of Plexiglas has a 200 μL sample chamber exposed to the taper. Analytes were introduced into the chamber either by pipetting or pumping through a tube using a peristaltic pump. Approximately 10 cm of protective tubing was inserted onto the fiber on both sides of the fiber holder. The tubing was then held in place using epoxy. The ends of the fiber were connectouized and polished (Thorlabs, NJ manufacturing procedure).

A 1550 nm DFB laser (Anmitsu GB5A016 having a maximum rated output power of 20 mW and peak wavelength of 1546.4 nm) was directed at the TFOB at a voltage setting of 5 mW, and the resultant light transmission through the fiber was measured. Since the fibers were already connectorized, a FC-FC mating sleeve (Thorlabs, NJ) was used to connect the fiber to the light source, and the other end of the fiber was connected to an optical spectrum analyzer (ANDO AQ-6310B).

### Example 5

Antibody immobilization may be accomplished according to the Bioconjugate Techniques described in Haddock, H. S., P. M. Shankar, and R. Mutharasan, Evanescent sensing of biomolecules and cells. Sensors and Actuators B-Chemical, 2003. 88(1) p. 67-74, with modifications for the fiber surface and geometry. The tapered region of the fiber was prepared prior to every sensing experiment using the following method: cleaning with 0.5 M sulfuric acid for 30 minutes, applying a Piranha solution (hydrogen peroxide and 6 M sulfuric acid in a volume ratio of 3:7) for 10 minutes and applying hot 0.1 M sodium hydroxide for 10 minutes. Following each cleaning step, the sample holder and fiber were rinsed several times with de-ionized water. The cleaning procedure produced reactive hydroxyl groups on tapered surface. The tapered surface was then silanylated with 0.4% 3-aminopropyl-triethoxysilane (APTES; Sigma-Aldrich) in de-ionized water at pH 3.0 (adjusted by sulfuric acid) and 75° C. for 2 hours. The fiber was then dried overnight in an oven at 50° C. The APTES reaction produced a free amine group at the glass surface, which becomes available for further reaction with carboxylic groups in the antibody to form a peptide bond. The polyclonal antibody was bound to BSA (anti-BSA; Sigma Catalog # B1520), which contains carboxyl groups activated by using 1-ethyl-3-(3-dimethylaminopropyl)-carbodiimide (EDC; Sigma-Aldrich) and stabilized by sulfo-N-hydroxysuccinimide (Sigma-Aldrich). EDC converts carboxylic groups into reactive unstable intermediates susceptible to hydrolysis. However, sulfo-NHS replaces the EDC producing a more stable reactive intermediate which catalyzes reaction with amine groups. Covalent bonding of this intermediate with the silanylated taper fiber surface was carried out at room temperature for 2 hours. During this time period, transmission through the fiber was monitored to determine the extent of antibody immobilization.

### Example 6

### Immobilization of Antibody to BSA

In BSA kinetics model, the observed rate constant, k_{obs}, is expected to differ at different concentrations of BSA and the antibody. The rate constant was found to be in the range of 0.02-0.08 min⁻¹ for the 10 pg/mL BSA, and 0.02-0.05 min⁻¹ for the anti-BSA. These values are comparable to 0.036 and 0.018 min⁻¹, which was obtained for anti-Bacillus anthracis rabbit and goat antibody respectively, in our laboratory for flat glass surfaces, at room temperature. In general, antibody immobilization took a longer time (about 40 to 60 minutes) while BSA attachment was of a shorter duration, typically 30 minutes. This time frame is again comparable to our earlier results.

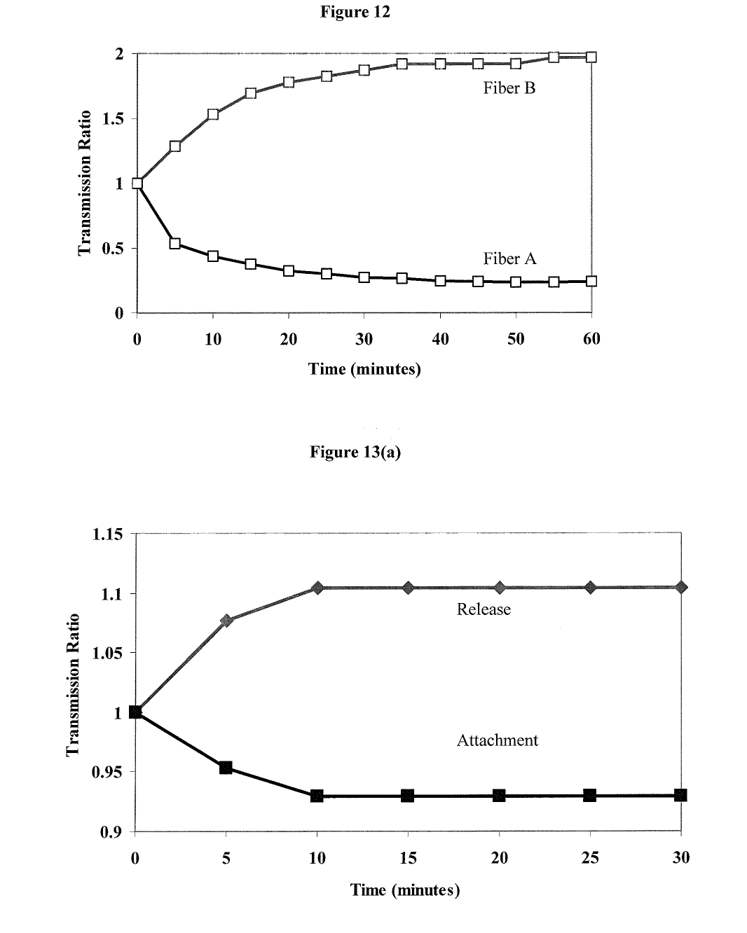

Reaction of anti-BSA with the amine-modified taper surface was monitored over the course of 2 hours by measuring the transmission through the fiber. This was performed with most of the tapered fibers that were subsequently used in BSA detection experiments. The ratio of transmission change during the immobilization is summarized in Table 2. Typical transmission response during anti-BSA immobilization is shown in FIG. 12, and one can see that transmission gradually changes over the first hour of reaction. Although the data is not shown, the transmission during the second hour of immobilization remained constant. During the first hour, the bonding of antibody to the fiber surface resulted in a small increase in fiber diameter as well as a change in refractive index at the taper surface. The antibody is about 13×6 nm, and the expected orientation is along 6 nm. Thus, the taper diameter is likely to change non-uniformly by about 12 nm, and such a change is expected to increase the transmission as more light is guided.

On the other hand, a change in refractive index due to the antibody immobilization may lead to increased or decreased transmission. In fact, for some fibers a similar amount of change in transmission was observed, but in the opposite direction as shown in FIG. 12. All the measurements are shown as a ratio of the steady state value at time equal to 1 hour normalized to the initial value following sample addition. From FIG. 12, one can see that the total change for fiber B at 60 minutes is twice the initial value, which is rather significant. The transmission of fiber A decreased to 24% of the initial value, which is a decrease of a factor of four, and is quite significant.

A summary of transmission ratios, and post-antibody immobilization at one hour to pre-antibody immobilization, is given in Table 2. From Table 2, it can be seen that for half of the tapers the transmission decreased when antibody was immobilized on the taper surface.

It appears that the increase or decrease is consistent with the direction of transmission change observed in PBS. PBS response is primarily due to a single refractive index change. That is, PBS solution is a homogenous liquid, and the liquid surrounding the taper has homogeneous optical properties. On the other hand, with antibody reaction, the surface goes through modification as antibody immobilization causes refractive index change at the surface (approx 10 nm thick), and beyond the 10 nm distance, the liquid is of a homogenous index. It should be noted that the surface concentration of the antibody is likely to be non-uniform. Thus, the two responses (PBS and antibody immobilization) could potentially be different in some cases. As one can see, in the cases of fibers E and F, the antibody response is opposite to the direction of PBS response.

### Absorption Characteristics of BSA and Antibody to BSA

The absorption of BSA and anti-BSA at 1550 nm was measured in a cuvette of 1 cm optical path using the same laser source that was used in the above measurements. The concentration of BSA used ranged from 10 pg/mL to 1 mg/mL. The concentration of anti-BSA used was 0.5 mg/mL. Upon introduction of the sample, the transmission stayed within noise levels of the instrument, 0.1 dB, compared to transmission in PBS, pointing to negligible or no absorption. This confirmed that BSA and anti-BSA do not absorb at 1550 nm, in the concentration range tested with an optical length of 1 cm. Since the optical path in the taper is much shorter than 1 cm, it is reasonable to conclude that changes in transmission observed in this embodiment during the TFOB measurements are due to refractive index effects, and that absorption effects are absent.

### Detection of BSA Attachment and Release

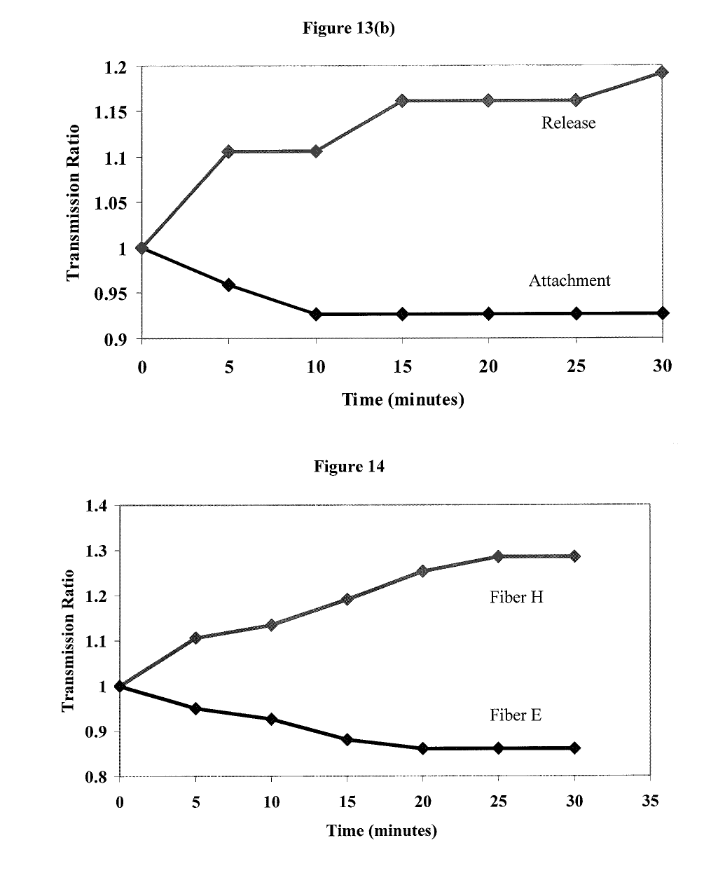

After the taper surface was immobilized with the antibody, it was rinsed with PBS, BSA was injected into the sample compartment and the transmission of light through the fiber was recorded. After 30 minutes, the BSA solution was removed and the sensor was rinsed with PBS. A pH 2 buffer (H₂SO₄ in PBS) was added to release the attached BSA. The pH 2 buffer weakens the binding of BSA to the antibody and releases it from the surface. The taper was then rinsed with PBS, and this cycle was repeated for higher concentrations. It was found that the taper was sensitive only for the first use. However, overnight drying returned the fiber to its original sensitive state even though the relevant data is not shown here. Both the attachment and release responses are shown in FIGS. 13(a) and 13(b), for concentrations of 10 pg/mL and 100 ng/mL respectively. It was found that with a concentration of 10 pg/mL one can expect a maximum change of 0.2. Similar experiments were performed with other tapers using different initial concentrations. The same optical fibers were washed and modified with APTES again before another set of measurements was made for the antibody attachment and BSA sensing. FIG. 14 shows the attachment of 100 pg/mL of BSA using two different fibers. From the data in the graphs, it appears that protein attachment to the sensor surface causes changes in the transmission characteristics. Release can be achieved by altering the pH of the medium. Also, the results show that the tests can be repeated with the same tapered fiber.

### Example 7

### Transmission in Tapered Fibers: Simulation Results

In general, when a taper waist is in air, a greater fraction of the light is transmitted through the fiber, as compared to the case when the waist is surrounded by water. This is because the V_{clad} value is higher when surrounded by air. In general, the larger value of V_{clad}, the greater and tighter is the confinement of light and thus higher transmission is obtained through the core. The tapers fabricated in this study exhibited this behavior with a few exceptions as summarized in Table 3. This property alone does not point to the utility of the tapers as sensors.

The light transmission is a function of the lengths of the contracting waist, and expanding regions of the taper, along with waist radius and the operating wavelength. It is suggested that the transmission in water may be higher than that in air when one considers all geometric aspects of the taper.

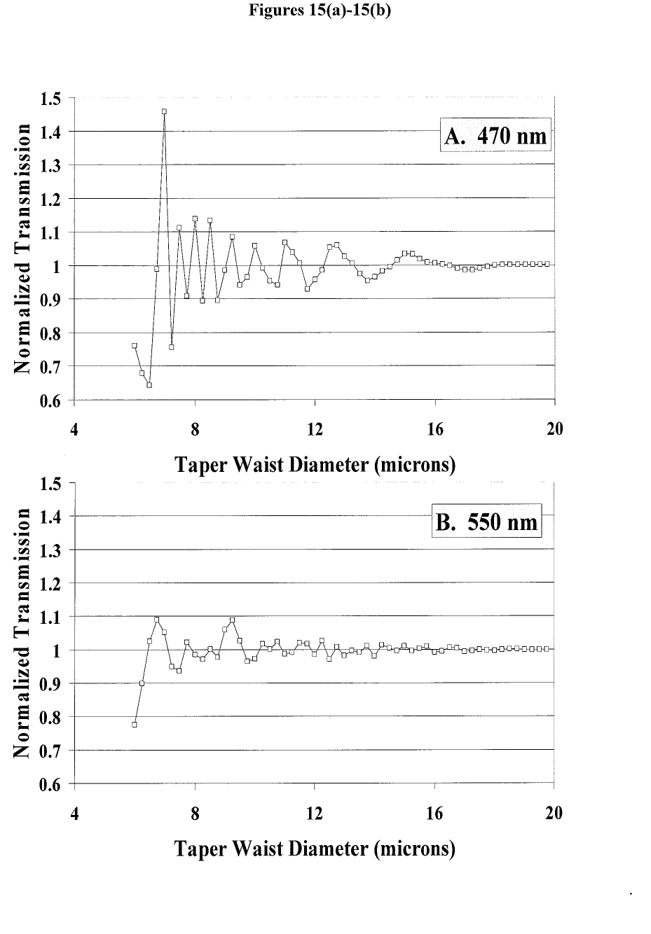

The light transmission characteristics of the tapers were simulated by calculating the transmission through tapers of various lengths and waist radii. Three modes, LP₀₁, LP₀₂ and LP₀₃ were used in the simulation. Since the light will be launched normally, the only modes to be excited will be the LP₀ₘ modes, with a majority of the light staying in the LP₀₁ mode. Sample simulation results, illustrated in FIGS. 15(a)-15(b), show changes in transmission for two geometries, a short symmetric taper and a long asymmetric taper, as a function of waist diameter. In Panel A, the taper geometry simulates that of a symmetric taper, while in Panel B, the simulation is for a long taper similar to a heat-drawn taper. The transmission is normalized with respect to air, so that a value of 1.2 indicates a transmission increase of 20% in water compared to air. The results in FIGS. 15(a)-(b) show that as the waist radius increases, the difference in transmission between water and air decreases. However, at intermediate values the ratio may be higher or lower than unity, particularly at smaller waist diameters. For specific values of the radius, the transmission through water is higher than in air. At a longer wavelengths (550 nm, for example) and for the same waist diameter values, the difference in transmission between air and water differ by less than 10%.

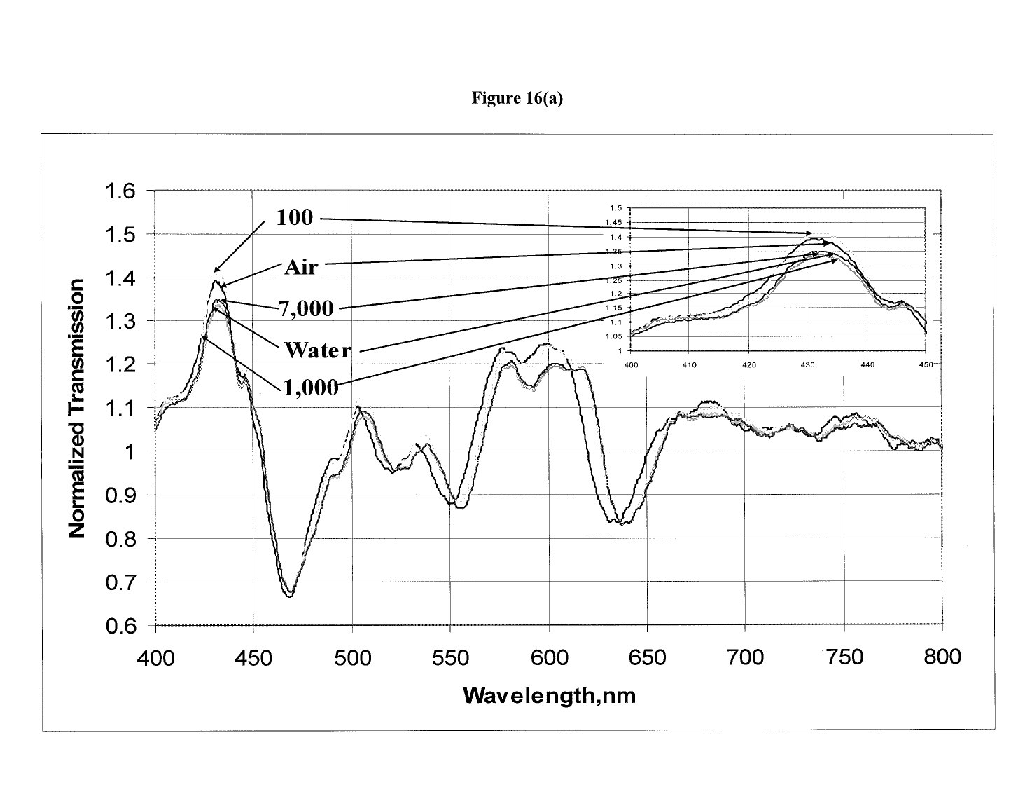

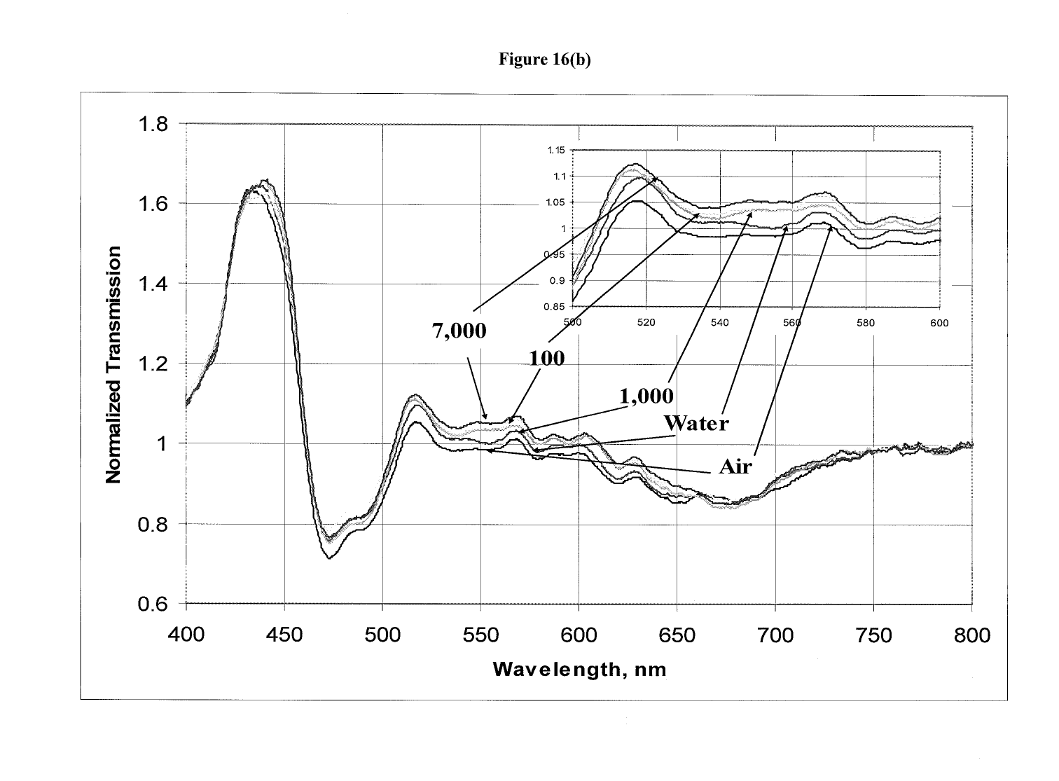

To explore further, simulation was undertaken by varying the diameter of the waist in much smaller steps of 0.001 μm. Computed transmission results are shown in FIG. 16 for two starting diameters, 5 μm and 6.25 μm. The transmission characteristics change rather significantly for small changes in diameter. For example, a 5.54 μm diameter taper exhibits 30% higher transmission in water, while a 5.58 μm waist diameter taper transmits 20% less transmission in water. The differences, however, become smaller for larger waist diameters. The example of 6.25 μm in FIG. 16 shows that the changes in transmission were less than 10%.

The simulation results merely serve as a guide to the analyses of the experimental data on the tapered fibers. It is important to recognize that in the simulation we have considered only the effect of refractive index (air and water) in the waist region, while in the actual sensing experiment, the cells absorb at the operating wavelength, and the resulting sensor response is a complex interplay of these two phenomena. In addition, because the cells constitute particulate matter, there is an additional complexity caused by inhomogeneity in the sample surrounding the taper waist. Furthermore, the cell attachment or adsorption onto the taper surface is often not uniform, thus compounding the sensor response further.

The transmission characteristics of the taper with water and air surrounding the waist are good indicators of the performance of the tapers as sensors. The hypothesis that no differential transmission between air and water clearly indicated tapers that had poor sensitivity. The sensitivity of the tapers is clearly determined by the profile parameters, namely the lengths of the contracting, expanding and waist regions and their relationship to the waist diameter and the operating wavelength.

### Example 8

### Air-Water Transmission Ratios

The ability of the tapers to operate as sensors was explored by exciting them with a white LED whose spectral output was in the range of 400 to 800 nm. The light transmission was measured with the tapered fiber waist exposed to air and submerged in water. The reason for the choice of these two media was that they provide the greatest expected difference in the refractive index in the waist region for biological samples. For example, whole cells of E. coli B/r H266 growing in minimal medium have a refractive index of 1.387±0.002. The tapers that exhibited weak changes in transmission when the medium surrounding the waist was changed from air to water, also showed weak sensitivity to ECJ suspensions. As summarized in Table 3, the tapers FS-51, HD-1, HD-2, HD-5 and HD-9 exhibited a water-to-air transmission ratio of nearly unity at 470 nm.

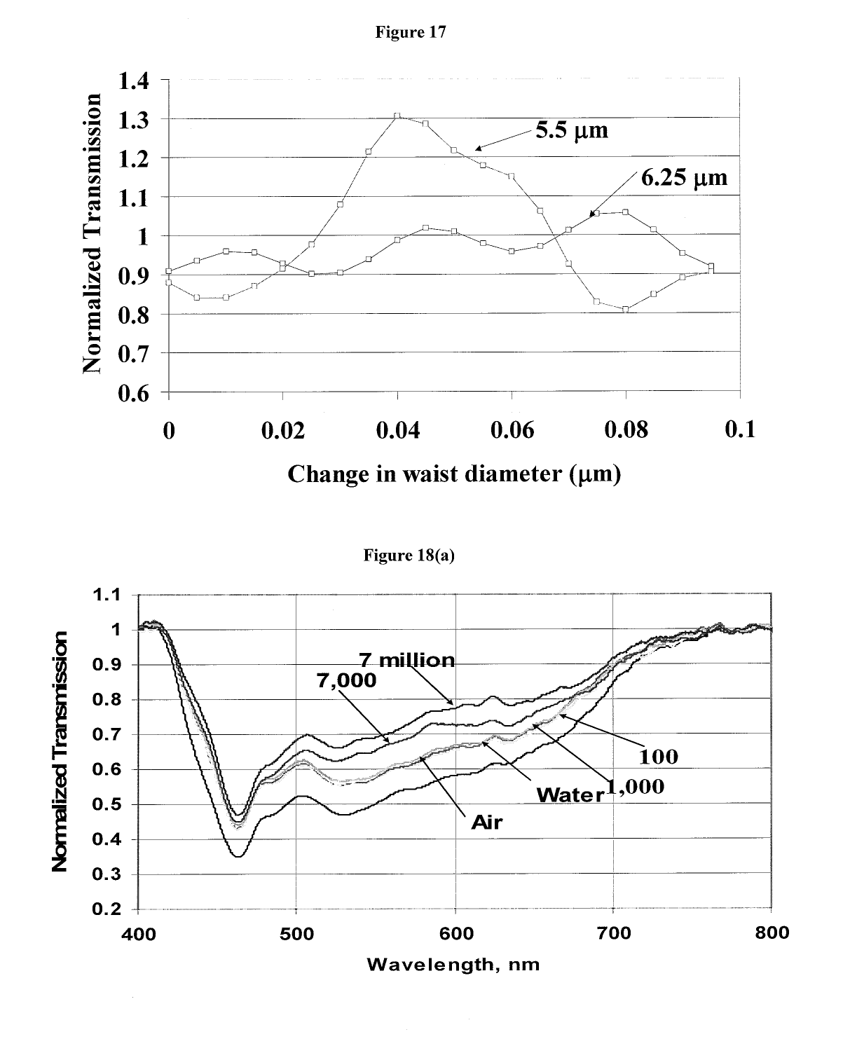

Two examples, HD-1 and HD-2, are shown from the various tapers that were characterized in FIG. 17. The responses were normalized with respect to the source transmission of a plain fiber, and then again normalized so that the value is unity at 400 nm. Thus, the normalized transmissions represent relative changes when an analyte is added to the taper, and allows comparison of results obtained from various tapered fiber sensor experiments. As shown in FIG. 17, both HD-1 and HD-2 show weak responses to cell suspensions. The magnitude of the change in transmission for ECJ concentration was less than 5%.

### Example 9

### Response of Fusion Spliced Tapers to Low Concentrations of E. Coli

Tapers that showed no relative change in transmission in water, as compared to air, also showed no or low response to the presence of ECJ suspensions. Both symmetric and asymmetric tapers of small and large waist diameters show this behavior, pointing to the lack of sensing ability of these tapers. Several tapers exhibited a significant difference in transmission in water, as compared to air. For example, FS-1, FS-2 showed nearly 50% reduction in transmission in water. These tapers also showed little or no ability to detect the presence of the ECJ cells (spectra not shown). In these cases, small changes in indices due to the presence of ECJ suspension were not sufficient to produce the changes in transmission, resulting in poor sensitivity. Any impact on the light through the fiber was already saturated from change due to water itself, such that the presence of ECJ suspension had little further impact. Other tapers that had this characteristic property, but were of smaller waist diameter showed weak sensitivity (FS2, FS4; spectra not shown). Most tapers that exhibited a significant difference in transmission in air and water media were symmetric tapers. The asymmetric tapers, on the other hand, showed lower relative transmission through water. Such tapers allowed further modulation in transmission due to the presence of ECJ and subsequent absorption when the concentration of the bacteria was high. The sensitivity was also determined by the wavelength as will be shown through simulation. To illustrate the above general observation, we examine specific cases in detail.

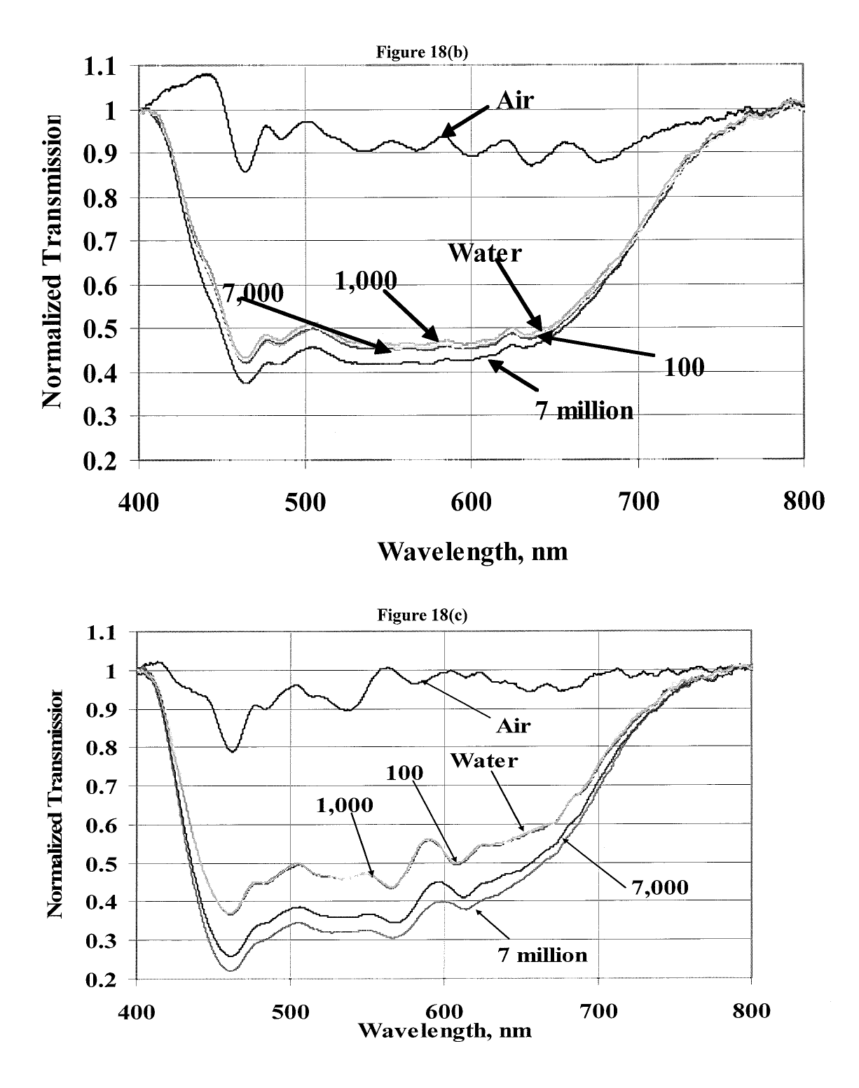

Responses of three fusion spliced tapers to air, water and a low concentration of the bacteria ECJ are shown in FIG. 18(a)-18(c). Several other tapers with almost identical geometric parameters exhibited similar behavior, and are not shown. For example, FS-162 showed a response similar to FS-158. The tapers FS-158 and FS-164 have nearly the same geometry except for the waist length and waist diameter. The waist length of FS-158 is about 30% longer, and the waist diameter about twice as large compared to FS- 164. With respect to the taper, FS-2 has nearly the same convergent length as the others, but its waist length is almost ten times that of FS-164, and its divergent length is twice as long as that of FS-158 and FS-164. The diameter of FS-2 is midway between the FS-158 and FS-164. The transmission response given in FIGS. 18(a)-(c) show that the symmetric taper, FS-158 with a waist diameter of 9.5 μm, was responsive to ECJ concentrations as low as 100 cells/mL. The responses to 1,000, 7,000, and 7 million cells/mL are also clearly discernable, and the transmission increases progressively with ECJ concentration. On the other hand, the shorter taper, FS-164, which has a shorter waist length and a smaller waist diameter is sensitive only at cell concentrations greater than 1,000 cells/mL. The longer taper, FS-2 with an intermediate waist diameter of 6.2 μm, was responsive at 7,000 cells/mL and higher.

Transmitted power is not a direct function of cell concentration. It is less for 7,000 cells/mL than for 1,000 cells/mL, while transmission for 7×10⁶ cells/mL is higher than that for 7,000 cells/mL. All three tapers are responsive in the 450 nm to 650 nm wavelength range. In this wavelength range, bacterial suspensions are known to absorb and thus a larger fraction of evanescent light in the above tapers was probably absorbed, thereby resulting in reduction in transmission. Note also that water/air transmission ratio of FS-158 is higher than unity (1.23 at 470 nm) while those of FS-164 and FS-2 are less than unity (0.49 and 0.48).

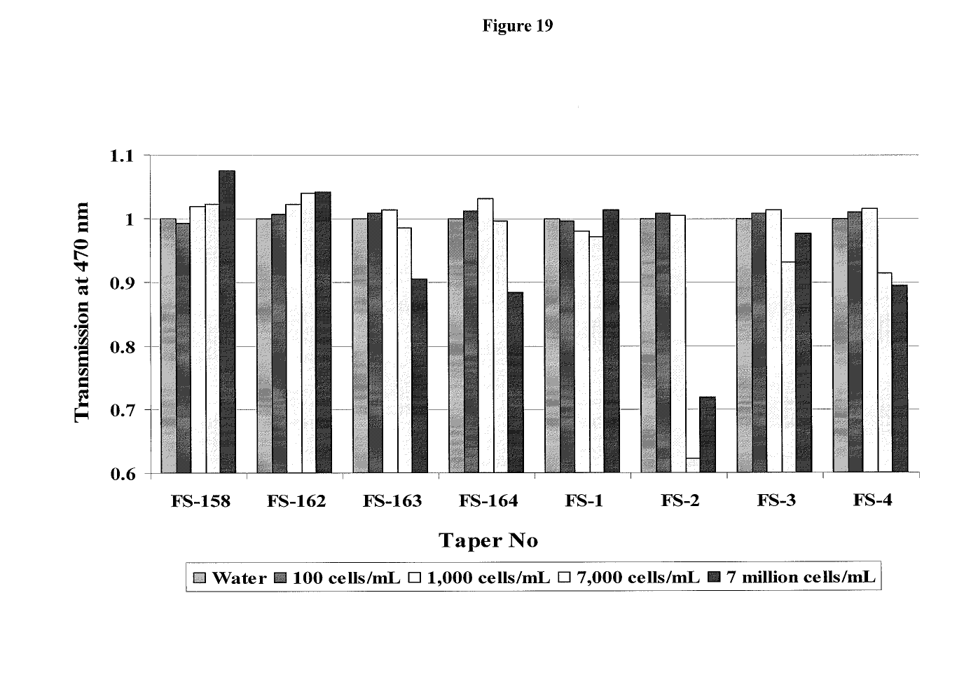

In FIG. 19, the relative transmission at 470 nm is compared for a number of tapers that were fabricated using the fusion splicer. In general, two types of responses are observed. In the first type, the transmission either increases or decreases monotonically as ECJ concentration increases. The tapers, FS-158 and FS-162 are two good examples of this behavior. In the second type, an initial increase in transmission for low cell concentration (for example, less than 1,000 cells/mL) is seen followed by a decrease at higher cell concentration. The tapers, FS-163, FS-164, and FS-4 are examples of this type of behavior. We also found that tapers such as FS-1, FS-2 and FS-3, that showed an increase in transmission at low ECJ concentrations, followed by a decrease in transmission at intermediate concentrations and then an increase in transmission at 7 million cells/mL. Although this type of response was uncommon among the tested tapers, these examples are included for completeness.

### Example 10

### Response of Heat-Drawn Tapers to Low Concentrations of E. Coli

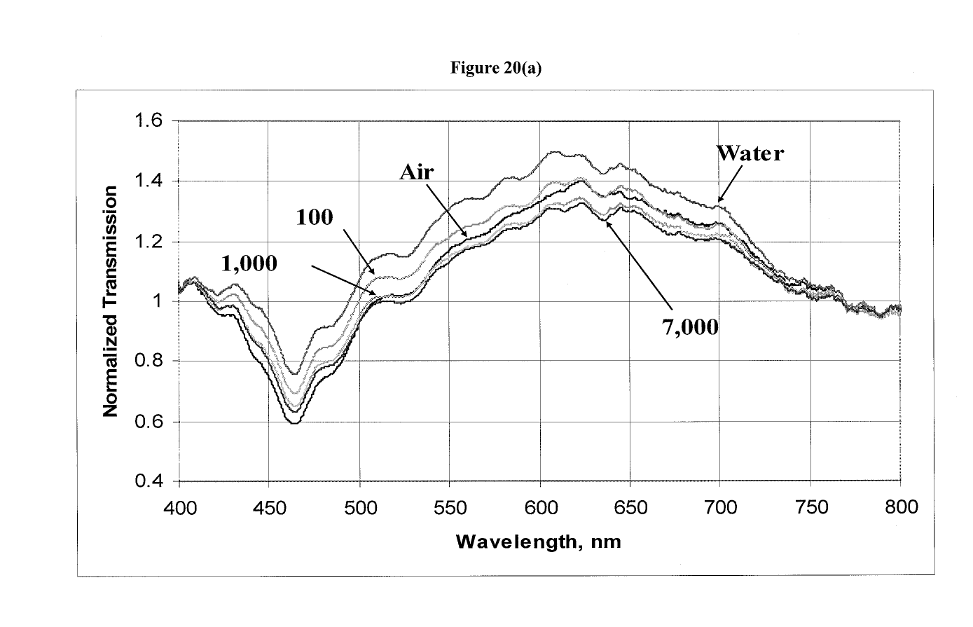

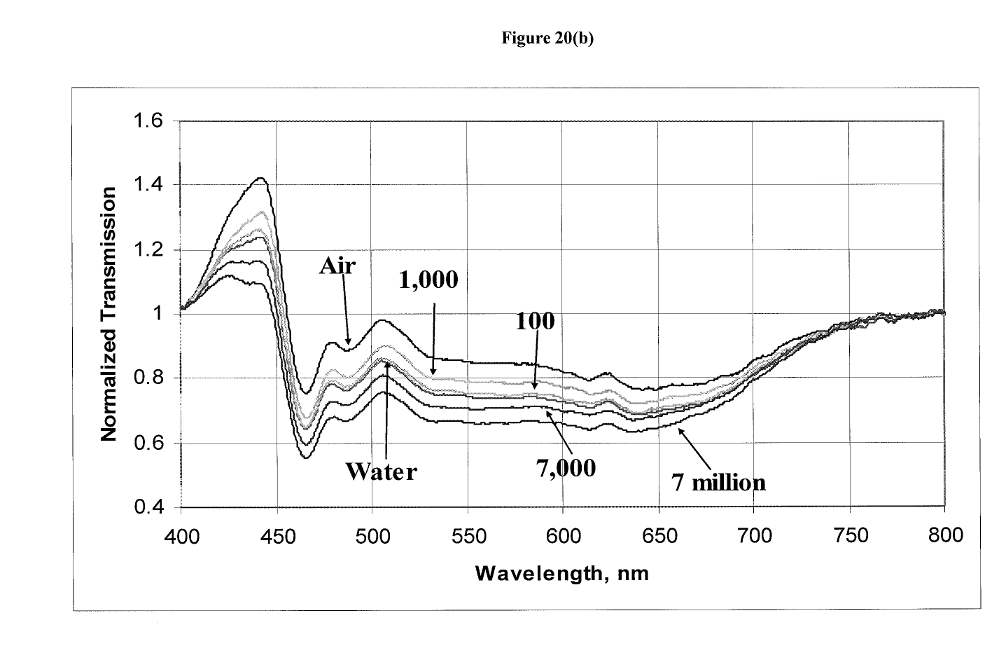

Heat-drawn tapers (see Table 1) have typically a much longer convergent waist and divergent sections, each on the order of millimeters, as compared to FS-tapers. FIG. 20 shows that transmission of HD-14 taper is responsive to the entire range of ECJ concentration tested, 100 to 7 million cells/mL. On the other hand, HD-7 was responsive at low cell concentrations, but was not responsive at high cell concentrations. The change from water to 100 cells/mL at 470 nm provided nearly a 7% change in transmission. Further increases in concentration caused further decrease in transmission, but the change was less pronounced. The decrease in transmission is presumably due to absorption of evanescent light by the cells. On the other hand, for HD-14, at low cell concentrations of 100 to 1,000 cells/mL, transmission increased, and upon a further increase in cell concentrations, the transmission decreased. That is, at high cell concentrations, lower transmission is seen due to increases cellular absorption of evanescent light. In general, the absorbance is proportional to the length of a uniform fiber. This phenomenon may be responsible for the monotonic relationship between transmission and concentration in the case of HD-7 for all cell concentrations tested, and in HD-14 at cell concentrations higher than 1,000 cells/mL.

With regard to wavelength response with HD-7 lower transmission was observed in 400-470 nm wavelength region, followed by an increase to over 150% relative transmission at 610 nm. HD-14, on the other hand, showed an initial increase to over 140%, followed by a sharp decrease to below 100%. The reversal of the responses is likely due to the effects of the refractive index, and is further discussed under simulation results.

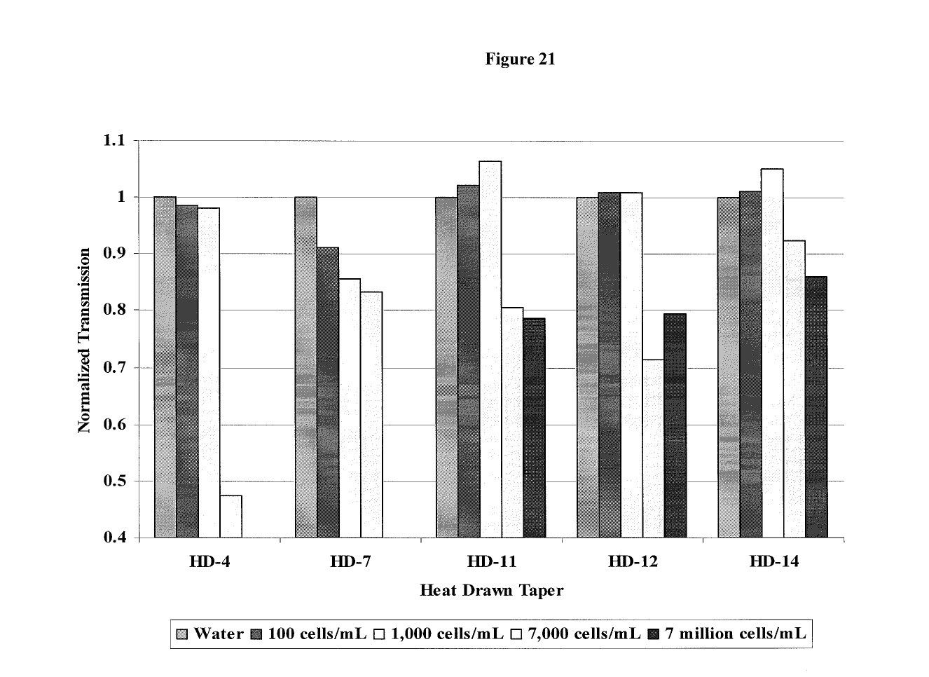

Of the fourteen heat-drawn fibers, the transmission response (normalized at 470 nm with respect to water) for a representative set is presented in FIG. 21. Analogous to the behavior of fusion spliced tapers, HD tapers showed two basic characteristics. In one case, tapers such as HD-4 and HD-7 showed a monotonic decrease in transmission; their sensitivity was found to be strong or weak at low cell concentrations and appeared to depend strongly on the waist diameter. In this particular case, HD-4 has a waist of 6.3 μm while HD-7 has a waist of 14.2 μm. HD-4 showed a decrease from a transmission of 0.98 at 1,000 cells/mL to a transmission of 0.47 at 7,000 cells/mL. In the other case, HD-11, HD-12 and HD-14 showed a slight increase in transmission when going from water to 100-1,000 cells/mL, and then a decrease in transmission for higher concentrations. As stated earlier, in these tapers at low concentration, the refractive index of the cellular suspension influences transmission response which causes the increase in transmission. At higher concentrations, the absorption of the evanescent light by the cells dominates the response.

The responses suggest that tapers fabricated by heat-drawing have excellent potential as biosensors.

### Example 11

A Tapered Fiber Optic Biosensor (TFOB) was used to monitor the real-time attachment of Bovine Serum Albumin (BSA) to an antibody-immobilized surface of the TFOB. A DFB laser emitting a long 1550 nm wavelength was used to direct a stream of light at one end of the tapered fiber while the optical throughput was monitored with an optical spectrum analyzer. Although cuvette measurements established that BSA was non-absorbing at 1550 mn showing no significant changes in optical throughput, tapered fibers with antibody immobilized surfaces were highly sensitive, detecting changes in optical throughput at bulk concentrations of about 10 fg/mL of BSA.

Without being bound, it is postulated that the increased sensitivity results because: 1) at 1550 nm, 8-12 μm waist diameters fibers change the optical characteristics of the tapered fiber and produce a strong evanescent field capable of heightened detection and 2) standard telecommunication single mode fiber at 1500 nm eliminates mode excitation problems observed at shorter wavelengths. Compared to the traditional short wavelength biosensors of about 300-400 nm, long wavelength sensors of about 1550 nm offer a highly sensitive means for observing protein-protein interaction by increasing the penetration depth of the evanescent field. Additionally, long wavelength lasers and detectors, particularly in the 1300-1500 nm range, are stable, inexpensive and commonly used in telecommunications.

The tapered optical fibers were fabricated according to the method of the present invention disclosed in Example 2 and prepared for antibody immobilization according to Example 3.

A 1 mg/mL BSA stock solution was then prepared in a 10 mM phosphate buffered saline (PBS) solution having a pH of about 7.4. Lower concentrations, of about 1 μg/mL, 100 ng/mL, 10 ng/mL, 1 ng/mL, 100 pg/mL, 10 pg/mL, 1 pg/mL, 100 fg/mL, were prepared in a PBS solution having a pH of about 7.4 by serial dilution. The absorption of BSA was measured in a cuvette using the same 1550 mn laser that was used in the taper detection experiments. A single mode FC fiber was used to connect the laser diode to the input of the cuvette holder (Ocean Optics, FL). Another FC fiber was connected from the output end of the cuvette holder to the same spectrum analyzer as the one used in the sensor experiments. Transmission characteristics of various BSA solutions, made by serial dilution in the concentration range of 10 pg/mL to 1 ng/mL, were measured. In the same way absorption of antibody to BSA at 500 μg/mL was also determined.

Solutions of BSA from 10 fg/mL to 1 mg/mL were prepared. Only one concentration was used in each experiment of attachment and release. After the taper surface was immobilized with the antibody, it was rinsed with PBS, and 200 μL of BSA was injected into the sample compartment and the transmission of light through the fiber was recorded. After 30 minutes, the BSA solution was removed and the sensor was rinsed with PBS. Then, the PBS solution was adjusted to a pH of 2 by adding H₂SO₄ to release the attached BSA. The resultant acidic PBS weakened the binding between the BSA and the antibody by changing the conformation of the protein, thereby releasing the protein from the surface. The fiber surface was then regenerated by sequentially cleaning the fiber surface with acid, base, and modification by APTES. Once the fiber surface was silanized, the cycle of antibody immobilization, BSA attachment, and BSA release was repeated.

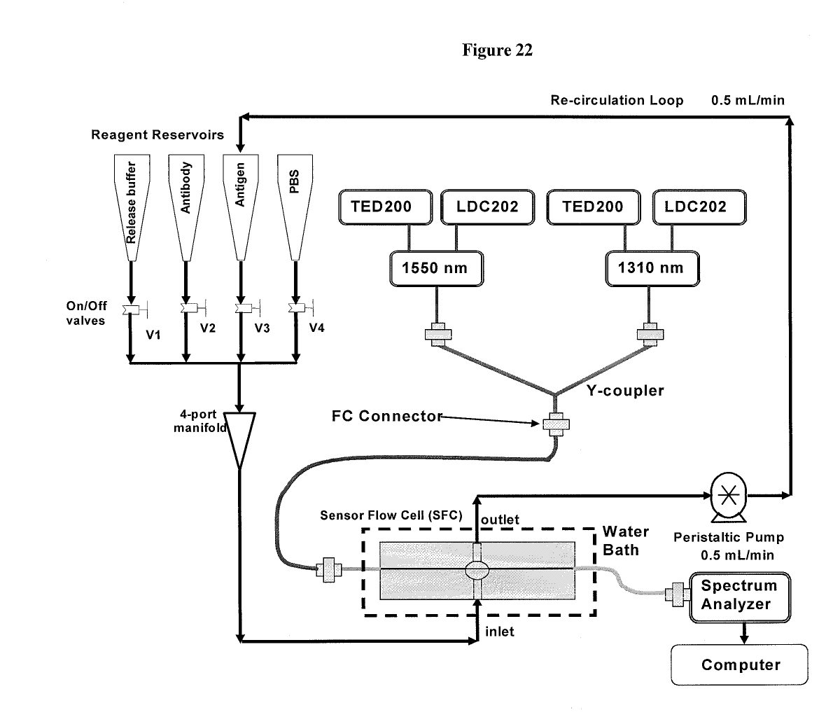

The multiple step attachment process, described above, was performed on three fibers with up to five different BSA solutions with concentrations ranging from 100 fg/mL to 10 ng/mL. The BSA solutions were added in order from the lowest to the highest concentration; after collecting data for up to 40 minutes, each sample was removed and the next BSA concentrated solution was added. FIG. 22 depicts a 50 μL sample chamber, maintained at 29±0.5° C., wherein samples are pumped into the chamber at 0.5 mL/min from a reservoir.

FIG. 2(b) shows an optical micrograph of one of the various fabricated tapers. The TFOB typically have a convergent length of 200-500 μm, waist of 50-200 μm and divergent length of 500-1200 μm. The waist diameters ranged between 6 and 12 μm. The tapers were tested for continuity and sensitivity to the presence of liquids by monitoring the optical throughputs when the waist was dry and when it was wetted with PBS.

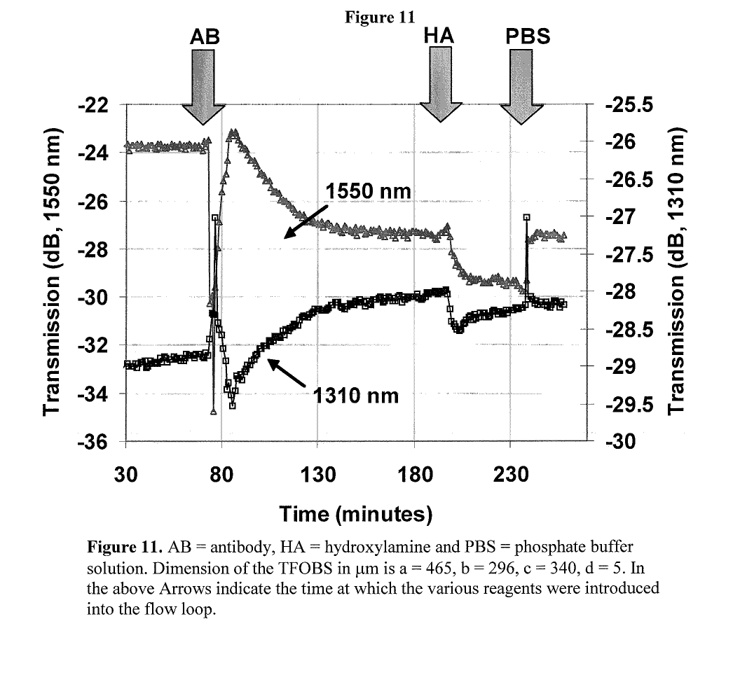

Reaction of anti-BSA with the amine-modified taper surface was monitored over the course of two hours by measuring the transmission through the fiber. Two typical transmission responses during anti-BSA immobilization are shown in FIG. 11. After 2 hours of antibody immobilization, hydroxylamine was then allowed to flow over the TFOB for 40 minutes, followed by PBS, until the transmission reached steady state. The temperature was controlled by an incubator and was maintained at 30±0.5° C. It is seen that the transmission gradually increased and reached saturated levels. Saturation usually occurred within two hours, and in FIG. 11 the responses are shown for up to 80 minutes because of the attainment of steady transmission. During the immobilization, bonding of antibody to the fiber surface resulted in a small increase in fiber diameter as well as change in refractive index at the taper surface. This type of surface reaction is analogous to adsorption of a protein onto a surface and can be modeled with the Langmuir model of adsorption. The antibody is about 13×6 nm, thus the taper diameter is likely to change non-uniformly by about 12 to 26 nm, and such a change is expected to alter the transmission characteristics. The measurements are shown as change in transmission following sample addition. From FIG. 11 one can see that the total change was 5 dB for one experiment, and 1.5 dB for the other. The difference in magnitude between the two responses resulted because the fiber surface was cleaned thoroughly between experiments, and antibody immobilization does not result in the same spatial coverage of antibody on the fiber surface every time. However, FIG. 11 shows that the antibody immobilization follows the Langmuir adsorption model closely in both experiments, as discussed later in section 5.

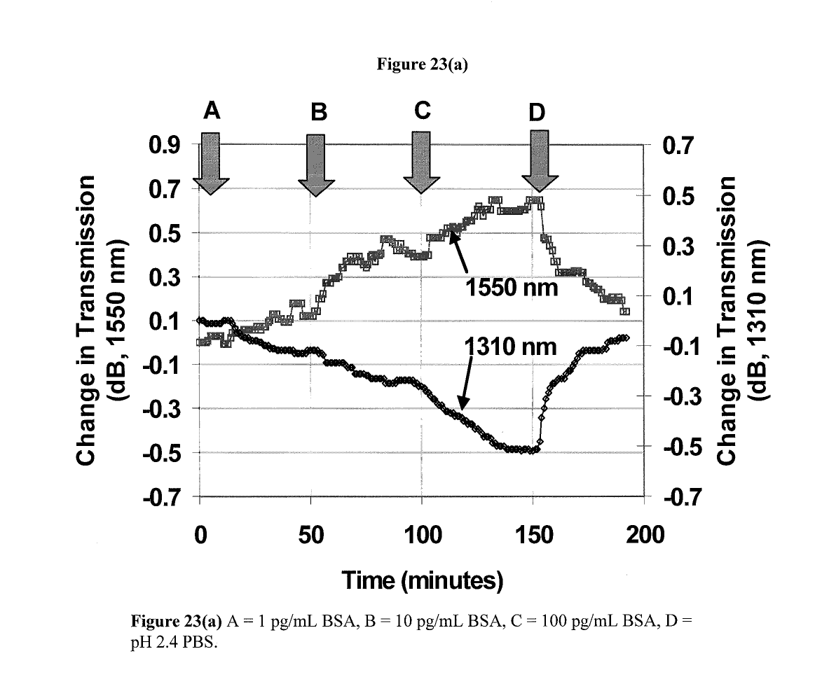

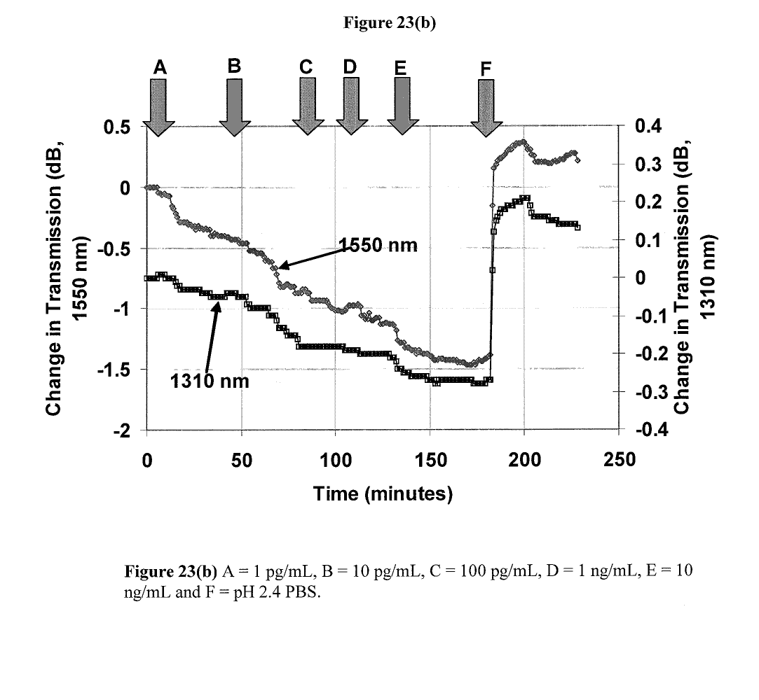

While the absorption of BSA in the UV wavelength region is well known, its absorption behavior in the near-IR region has not been characterized. The absorption of BSA and anti-BSA at 1550 nm was measured in a cuvette of 1 cm optical path using the same laser source that was used in the sensing experiments. The concentration of BSA used ranged from 10 pg/mL to 1 ng/mL. The concentration of anti-BSA used was 0.5 mg/mL. Upon introduction of the sample, the change in transmission stayed within noise levels of the instrument, 0.1 dB, compared to transmission in PBS, pointing to negligible or no absorption as shown by FIGS. 23(a)-23(b). FIG. 23(a) graphical documents the change in transmission when BSA solutions of 1 pg/mL to 100 pg/mL were attached sequentially to this fiber, followed by the addition of a PBS solution having a pH of about 2.4 to release the protein. FIG. 23(b) BSA of 1 pg/mL to 10 ng/mL were attached sequentially to this fiber, and then pH 2.4 PBS was flowed in to release the BSA. pH 2.4 PBS causes the opposite change in transmission, with the almost same value as the value prior to any BSA addition, thus confirming the attachment of BSA in the first place. FIG. 23(b) shows that a PBS solution having a pH of about 2.4 causes the opposite change in transmission, producing almost the same transmission value as that prior to any BSA addition, confirming the attachment of BSA. This suggests that BSA and anti-BSA do not absorb at 1550 nm, in the concentration range tested with an optical length of 1 cm. Since optical path in the taper is much shorter than 1 cm, it is reasonable to conclude that changes in transmission observed in TFOB experiments are due to refractive index effects, and that absorption effects are absent.

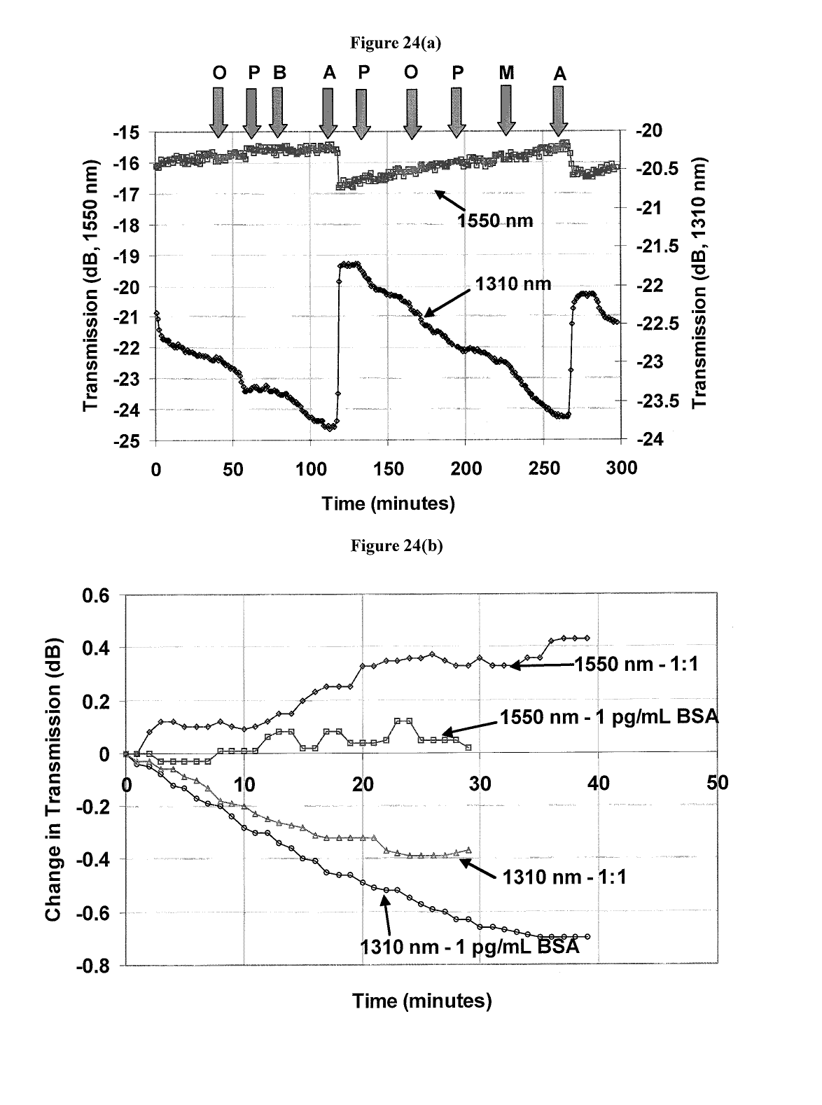

FIGS. 24(a)-24(b) show the attachment and release responses for BSA concentrations of about 10 pg/mL. The graph records the change in transmission associated with the addition of 1 pg/mL of BSA, release with 2.4 pH PBS solution and the addition of a 1:1 mixture of 1 pg/mL of BSA and OVA, where O=1 μg/mL OVA, P=PBS, B=1 pg/mL BSA, A=pH 2.4 PBS, M=1:1/v:v mixture of 1 pg/mL BSA and 1 pg/mL OVA. When BSA was injected into the sample holder, transmission decreases due to change in surface refractive index caused by the presence of BSA. A low pH PBS was then added to change the conformation of the proteins so as to loosen the binding between the antibody to BSA and the BSA. When BSA is loosened and released from the antibody, transmission increases back almost to the starting value. Similar experiments were performed with other tapers using different initial concentrations, and we conclude that experimental results are reproducible with the different fibers. Unfortunately, due to limitations with the fabrication the fibers could not be re-used repeatedly as anticipated initially, therefore each experiment was only repeated 2 or 3 times. Similar to the antibody attachment to the fiber surface, the binding of BSA and anti-BSA appears to follow the Langmuir adsorption model. However, here the time scale for saturation is about 10 minutes whereas it was about 1 hour for the antibody.

Experiments established that the TFOB is capable of sensing 10 fg/mL of BSA and that the detected change in transmission is based on a change in the refractive index caused by adsorption on the surface of the fiber.

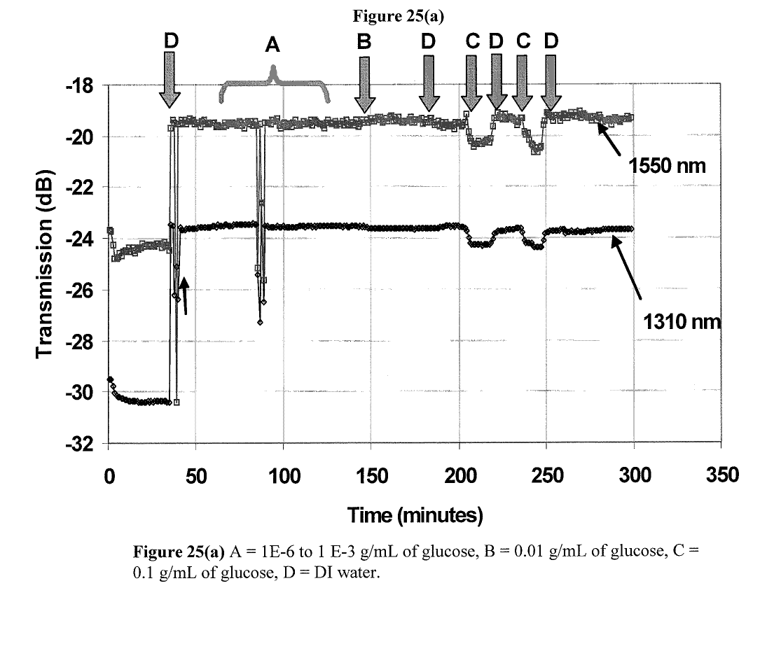

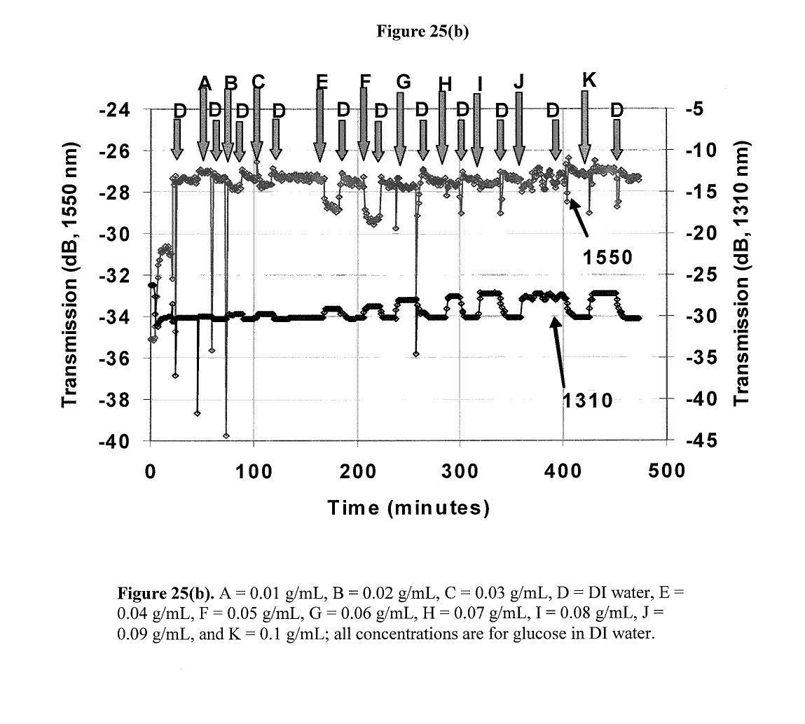

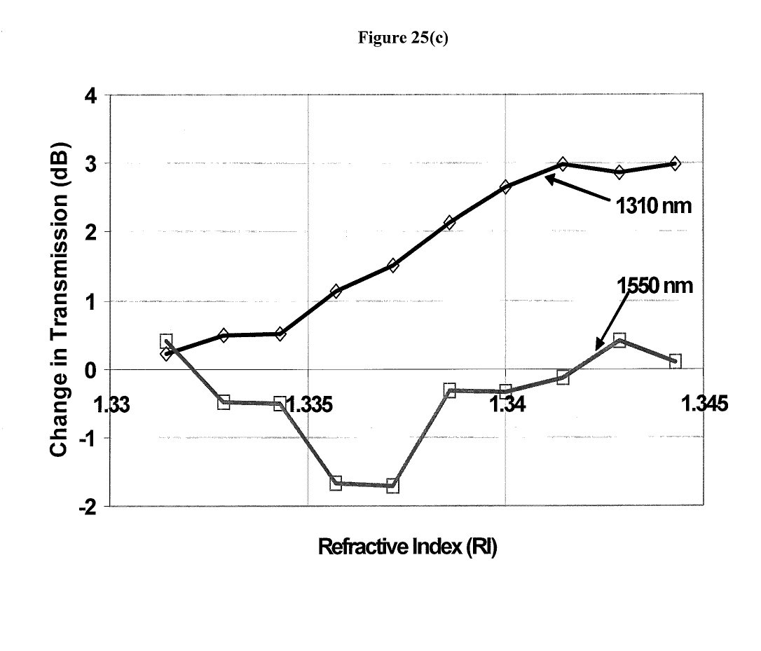

In three separate experiments, the TFOB was exposed to 100 fg/mL of BSA for 30 to 40 minutes. The transmission was recorded every five minutes and the raw data is presented in FIGS. 25(a)-25(c). FIG. 25(a) shows that there was no response from 1E-6 to 1E-3 g/mL of glucose, but there was a slight response starting at 0.01 g/mL of glucose. There was a large response at 0.1 g/mL of glucose. FIG. 25(b) shows a non-specific response for the concentration range of 0.01 to 0.1 g/mL glucose. One can see that although the experiments were performed using different fibers after thorough cleaning, the direction of transmission change is the same, and the transmission changes are in the same order of magnitude. Based on the largest change of 5 dB that resulted from 100 fg/mL, it is reasonable to assume that even lower concentrations can be sensed.

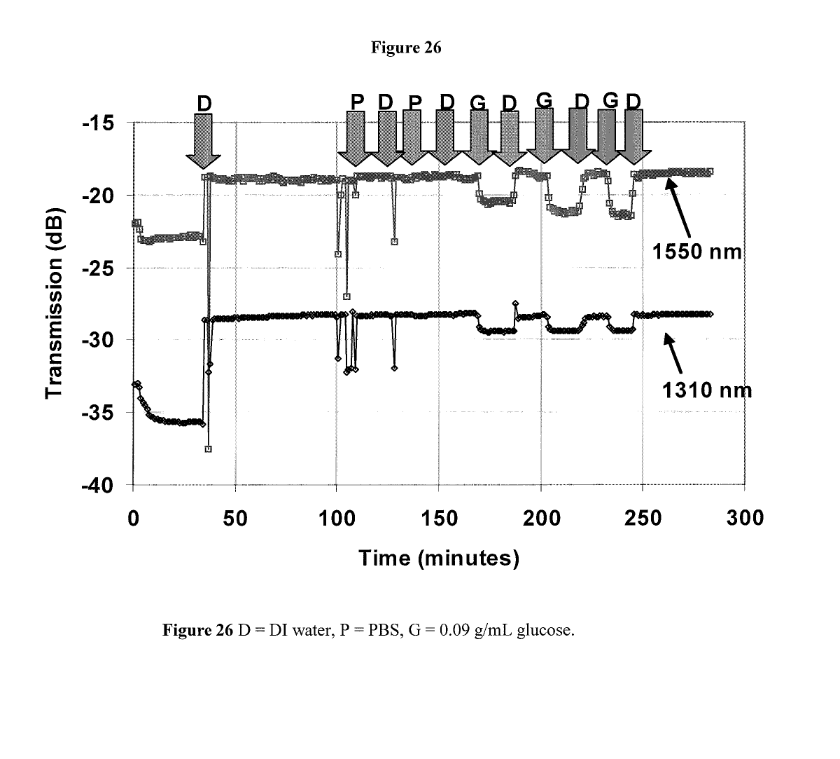

In one experiment, the ability to sense 10 fg/mL BSA was observed in FIG. 25. The taper was first exposed to 10 fg/mL of BSA for 30 minutes and then higher concentrations of up to 10 pg/mL; FIG. 26 recorded the detection sensitivity. Data was collected automatically every minute. Like the responses shown in FIG. 25, the transmission decreased as a function of time as BSA attached to the antibody. The steady state value of transmission reached at each concentration also decreased. The relationship between concentration-dependent steady state transmission and time was indicated by connecting the steady state values reached subsequent to each addition by a dotted line on the same graph.

From these results, it is seen that the change in transmission is not linearly proportional to concentration. Without wishing to be bound, at low concentrations, the surface of the fiber is not saturated with the antigen BSA. An estimate of the antibody/antigen surface coverage of the fiber can be made with a few simplifying assumptions. Using a convergent length of 400 μm, waist length of 100 μm, divergent length of 1000 μm, and waist diameter of 12 μm, the surface area is estimated as 2.8×10⁻⁷ m². Given the diameter of gyration of each BSA molecule is 35.9 Å and BSA has a molecular weight of 67 kD, it is estimated that it would require 6.9×10⁹ molecules to completely cover the taper surface if uniform coverage is assumed. A 0.2 mL sample containing 10 pg/mL of BSA has enough BSA molecules to cover less than 0.26% of the taper surface. In the ideal case it would require about 4 ng/mL of 0.2 mL BSA sample to saturate the surface of the fiber. Due to the likelihood that antibody coverage of surface is likely to be less than 100%, it is suggested that the concentration required for saturation is less than 4 ng/mL.

Transmission changes observed are caused by the evanescent field interaction with the surface layer of antigen. Once the concentration approaches ng/mL levels, the surface of the fiber would become saturated with a single layer of BSA. Additional BSA molecules would need to attach on top of the layer closest to the fiber surface. However, the evanescent field magnitude decays away from the surface. Therefore the effect of any BSA on top of the first layer results in much smaller changes. In addition, the condition for immobilization varies from one experiment to another. It is possible that nonlinearity was observed in terms of transmission change based on concentration because at the lowest concentration, the bulk refractive index is approximately the same as that of PBS, and the small number of BSA molecules on the fiber surface acts as isolated points of high refractive index perturbation. When the concentration increases to saturation point, the fiber surface is covered with a monolayer of BSA which has a higher refractive index than PBS. Thus the transmission changes that can occur depend on the condition of the fiber surface, which in turn depends on the concentration of BSA. With improvements in immobilization repeatability and mathematical modeling, it should be possible to obtain a more predictable relationship between the transmission changes and analyte concentration.

Another interesting feature of the staircase experiments given in FIG. 26 is that the existence of variation in the rate of attachment at different concentrations. It appears that the rate is more rapid initially, when the sensor surface is virgin, and becomes slower as binding sites become less available, as in the case of higher concentrations of analyte. The dotted line shown in FIG. 26 represents the steady state values of transmission achieved after the addition of each concentration. Based on the changing slope of this dotted line, it appears that there is a decrease in rate of attachment as concentration increases.

Tapered fiber optic biosensors exhibited strong transmission changes at 1550 nm when antibodies bind to the TFOB surface and when the BSA antigens bind to the antibodies. The general BSA detection range is about 100 fg/mL. FIG. 26, however, proves that the TFOB may also detect the presence of BSA at 10 fg/mL. FIG. 26 shows that there was no difference in transmission caused by PBS and DI water but that there was a large response caused by 0.09 g/mL glucose. After flowing in 0.09 g/mL glucose, the transmission was restored to the original value by the introduction of DI water. Further flow of 0.09 g/mL glucose yielded the same response as previous additions. The response of TFOB was found to be about one hour for antibody immobilization, and about 30 minutes for the antigen binding. The sensitive detection capability of TFOB results from its ability to detect changes in transmission, which correspond to change in refractive index due to surface adsorption.

### Example 12

### Effect of Concentration on TFOB Response

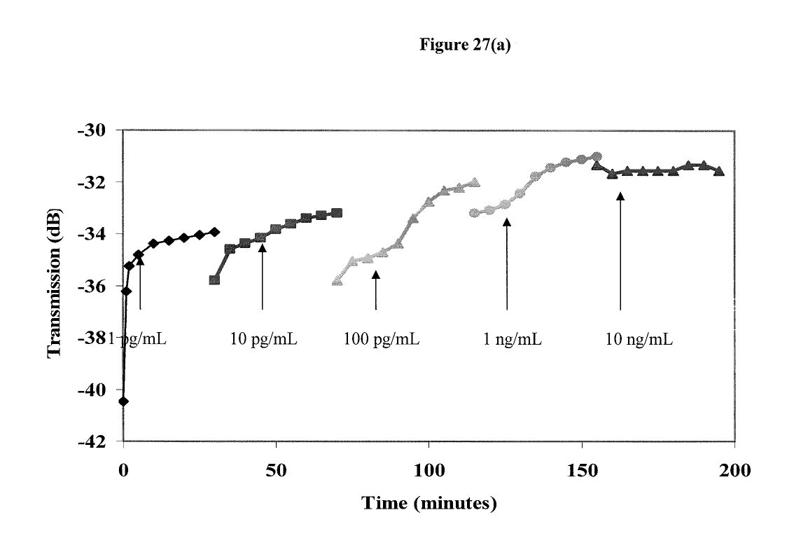

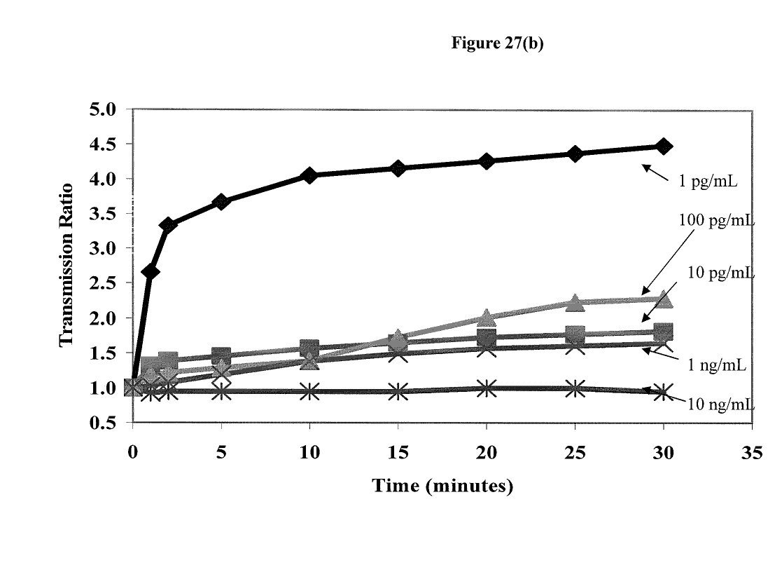

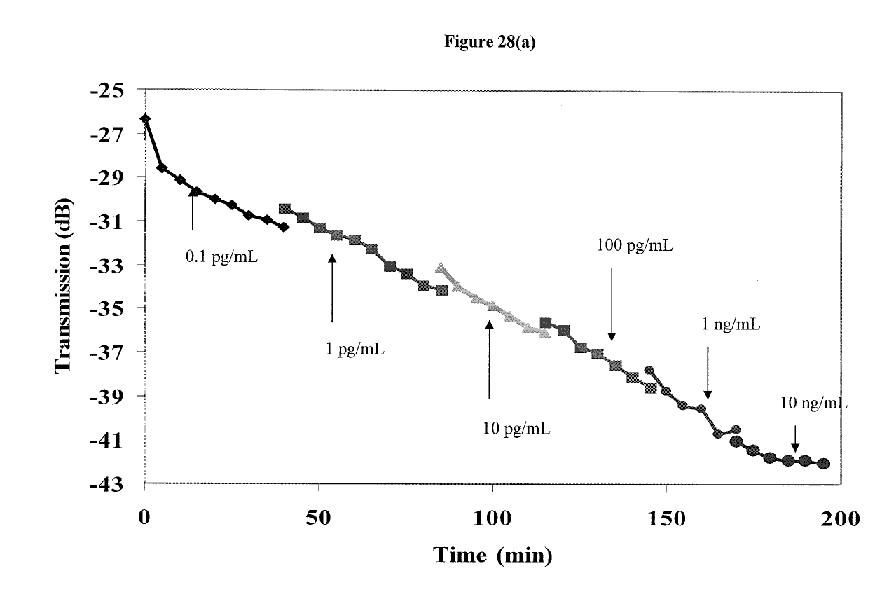

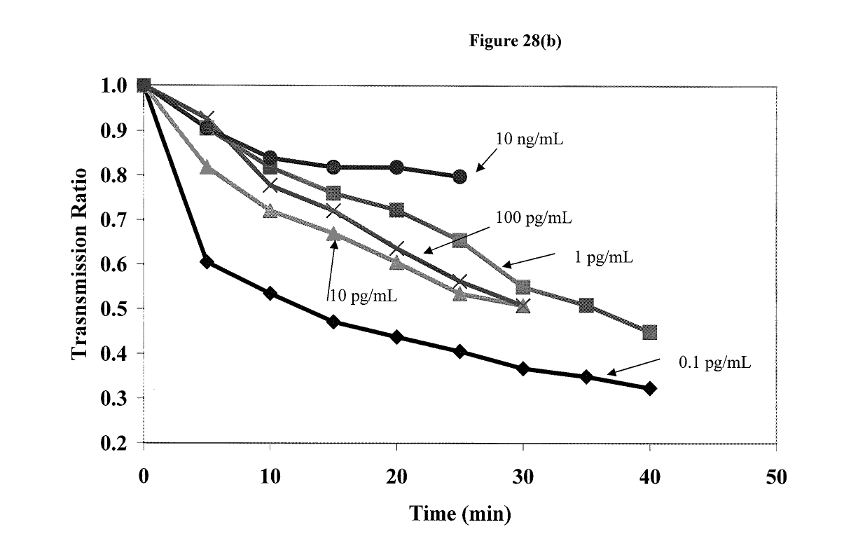

Having established that both antibody immobilization and subsequent attachment of the antigen BSA at 10 pg/mL can be measured, a series of measurements were conducted to examine the lower limits of detection. In order that the same set of conditions be used, the prepared sensor was first exposed to 1 pg/mL or 100 fg/mL of BSA for 30 to 40 minutes, and then exposed to higher concentrations following removal of the previous sample. Upon injection of the least concentrated sample, the transmission was recorded every five minutes, and the raw data is presented in FIGS. 27(a) and 28(a) for starting concentrations of 1 pg/mL and 100 fg/mL, respectively. After each sample was added, the transmission changed gradually over a period of 30 to 40 minutes but did not reach steady state. Only up to 40 minutes of measurements were taken for each sample in order to maintain the same set of conditions as those described above. At the end of each 40-minute attachment episode, the sample was removed and the next sample was injected without rinsing the taper. Because of exposure to air during sample removal, the initial transmission of each sample was not the same as the last data point recorded for the previous sample. Therefore, in addition to the raw data, the transmission data is also presented as a ratio normalized to the initial value upon injection of each sample. These normalized curves are shown in FIGS. 27(b) and 28(b) for starting concentrations of 1 pg/mL and 100 fg/mL, respectively. Note that in FIG. 28(b) the curve for 1 ng/mL has been omitted because it is extremely close to the curve for 1 pg/mL. FIGS. 27(b) and 28(b) show that the percentage of change is much larger in the case of low BSA concentrations. For example, the measurement represented by FIG. 27(b) detects concentrations of BSA from 1 pg/mL to 10 ng/mL. The response ratio for 1 pg/mL was 4.5 whereas the response ratio for 10 ng/mL was much smaller and was close to 1. This inverse relationship between concentration and response is seen again in FIG. 28(b), which represents the same detection data but involving concentrations from 100 fg/mL to 1 ng/mL. From FIG. 28(b), the response to 100 fg/mL showed a change of 0.68, whereas the change was 0.2 for 10 ng/mL. The reason for this may be that at small concentrations, the surface of the fiber is not saturated with the antigen BSA. Therefore any signal detected would include the result of the evanescent field interaction with the surface layer of antigen. At higher concentrations however, the surface of the fiber would become saturated with antigen and the response becomes weaker.

Estimates of antibody/antigen surface coverage of the fiber can be made with a few simplifying assumptions. Using a convergent length of 400 μm, waist length of 100 μm, divergent length of 1000 μm, and waist diameter of 12 μm, the surface area is estimated as 2.8×10⁻⁷ m². Given that the diameter of gyration of each BSA molecule is 35.9 Å and BSA has a molecular weight of 67 kD, it is estimated that it would require 6.9×10⁹ molecules to completely cover the taper surface if uniform coverage is assumed. A 0.2 mL sample containing 10 pg/mL of BSA has enough BSA molecules to cover less than 0.26% of the taper surface. In the ideal case, it would require about 4 ng/mL of 0.2 mL BSA sample to saturate the surface of the fiber. Due to the likelihood that antibody coverage of surface is likely to be less than 100%, it is suggested that the concentration required for saturation would be less than 4 ng/mL.

Another feature of the staircase experiments given in FIGS. 27 and 28 is that one can see the difference in the rate of attachment at different concentrations. It appears from FIGS. 27 and 28 that the rate is more rapid initially, when the sensor surface is virgin. The measurements in FIGS. 27 and 28 have each been repeated successfully, and with good reproducibility. With the exception of the 100 fg/mL and 1 pg/mL concentrations in the staircase experiment, it appears that one can expect the change in transmission to be much greater when antibody was immobilized, as compared to BSA attachment or release. In comparison to the levels of changes in transmission for the antibody attachment, the changes for BSA binding are quite low. For example, the largest ratio of transmission change caused by antibody attachment was 2, while that of 10 pg/mL of BSA was 0.2. This may be due to the antibody being much closer to the taper surface, so that interaction of the evanescent field with the surface-bound antibody is higher. After immobilization, there is already a layer of antibody on the taper, and therefore the BSA interacts only with the outer portion of the evanescent field, which is weaker than the field at the taper surface and thus results in a lower level of changes.

### Example 13

In one embodiment of the invention, silica single mode (at 1300 nm) Corguide optical fiber (Corning Glass Works, NY) with a core diameter of 8 μm and an overall diameter of 125 μm was used in all sensors. After removing the polyacrylic sheathing, the fiber was cleaned with isopropanol, cut using a fiber cleaver (Ericsson EFC11), and inserted into a programmable fusion splicer (Ericsson FSU 975) for tapering. For an asymmetric taper, a free weight was attached to one end of the fiber instead of the splicer clamp. Heat-drawn tapers, on the other hand, were fabricated as per Rijal et al., 2005, cited above.

### Example 14

It was shown that by introducing a small bend in the taper waist, the efficiency of the tapered sensors matched those of the interferometric fiber sensors. Recently, tapers of waist diameter in the range of 3-4 μm have been fabricated using chemical etching and heat pulling. Tapered fiber may be used as a delivery and collection device for fluorescence sensing.

Tapered fibers were fabricated using the heat pulling to a waist diameter of 3.11 μm. The fluorescent agent used was fluorescin with absorption in the 460 nm and 502 mn range. The emission was in the vicinity of 516 nm. Both the excitation and emission characteristics of the agent were confirmed using the traditional cuvette. Light at 460 nm was launched into the fiber. The PMT was set to collect light in 516±5 mn. Increased levels of fluorescence were seen with increased levels of fluorescin. The observed fluorescence could have been excited only from the light transmitted through the fiber interacting with the medium outside via the evanescent field. Since the tapered fiber had not been cut and all the possible avenues of light leakage into the PMT were eliminated, the fluorescence measured is due to the emission guided back into the fiber through the evanescent coupling mechanism. These results suggest that the tapered fiber can act, both as a delivery mechanism of the excitation energy to the analyte outside the fiber and act as a receiver simultaneously collecting the longer wavelength fluorescence. Even though the emission counts are much lower than those seen with the cuvette arrangement, fluorescence emission observed validates the principle that fluorescence can be measured using tapered geometry. These results establish the uniqueness of a tapered fiber as fluorescence sensor.

The fluorescence lifetime of disodium salt of β-NADH in TRIZMA buffer (pH 7.7) mixed with lactate dehydrogenase (LDH) at various relative mol ratios was also measured. FIG. 13 shows the typical time response at 1.05 mol ratio along with excitation pulse. Measurement was made in a faculty colleague's laboratory using PTI fluorometer equipped with nanosecond nitrogen flash lamp pulsed at 5 ns. Signal response was obtained with 814 PMT coupled to a monochromator, and a sample result is given in FIG. 4. As shown in Table C1, the lifetime increases as NADH binds to the dehydrogenase. In intracellular environment, it is the bound form that is indicative of metabolic activity while the free form simply indicates the reductive potential present in the cell.

Having described the preferred embodiments of the invention which are intended to be illustrative and not limiting, it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, the intended scope of protection is set forth in the appended claims.

1. A tapered fiber capable of detecting an analyte in a liquid or vapor comprising:
an optical fiber having first and second ends and a tapered region having a diameter smaller than a diameter of said fiber at one of said ends, said tapered region being located between said first and second ends.

2. The tapered fiber of claim 1, wherein the tapered fiber is substantially cylindrical and comprises a waveguide inner core component and an outer cladding comprising an evanescent component.

3. The tapered fiber of claim 2, wherein the waveguide inner core comprises Ge-doped silica and the evanescent component comprises pure silica having a lower refractive index than the core.

4. The tapered fiber of claim 2, wherein the tapered fiber comprises a tapered grating that creates an optical resonator.

5. The tapered fiber of claim 1, wherein the tapered fiber is capable of detection at a sample concentration of less than 10 pg/mL.

6. The tapered fiber of claim 1, wherein the biosensor is capable of detection at a sample concentration of less than 10 fg/mL.

7. The tapered fiber of claim 1, wherein the tapered fiber is capable of detection at a wavelength of from about 850 nm to about 4000 nm.

8. The tapered fiber of claim 1, wherein the tapered fiber is capable of detection at a wavelength of from about 1100 nm to about 2500 nm.

9. The tapered fiber of claim 1, wherein the tapered fiber has a length greater than 0.1 mm and a waist diameter taken in the tapered portion of less than 25 m.

10. The tapered fiber of claim 1, wherein the tapered fiber has a waist diameter of from about 1 μm to about 25 μm taken in the tapered portion, and a taper length of about 0. 1 mm to about 10 mm.

11. The tapered fiber of claim 1, wherein the tapered fiber has a waist diameter of from about 1 μm to about 7 μm taken in the tapered portion, and a taper length of about 0.6 mm to about 1.2 mm.

12. The tapered fiber of claim 1, having a tapered portion that is engineered for detection of a specific analyte.

13. The tapered fiber of claim 12, wherein the tapered portion further comprises an antibody for a specific analyte bound to an inner surface of said tapered portion.

14. The tapered fiber of claim 1, wherein the tapered fiber is biconical.

15. A tapered fiber optic biosensor, comprising:
a tapered fiber as claimed in claim 1,
a light source operatively associated with said tapered fiber to provide light to the first end of said tapered fiber;
and at least one detector operatively associated with said tapered fiber for receiving light from the second end of said tapered fiber;
wherein the detector is capable of monitoring refractive index changes and the interaction between at least one analyte and an evanescent field in order to determine the presence and/or concentration of said analyte.

16. The tapered fiber optic biosensor of claim 15, wherein the biosensor is portable and microscaled.

17. The tapered fiber optic biosensor of claim 15, wherein the biosensor is enabled for in situ on line measurement of an optical throughput.

18. The tapered fiber optic biosensor of claim 15, wherein the biosensor is integrated in a device selected from the group consisting of glucose strips, pregnancy kits, MEMS, biopsy probes, endoscopes and catheters.

19-28. (canceled)

29. The tapered fiber of claim 1, wherein the tapered fiber has a waist diameter of from about 1 μm to about 15 μm taken in the tapered portion, and a taper length of about 0.5 mm to about 5 mm.

30. The tapered fiber of claim 1, wherein the tapered fiber has a waist diameter of from about 1 μm to about 25 μm taken in the tapered portion, and a taper length of about 0.1 mm to about 10 mm.
